(19) United States
(12) Patent Application Publication
(10) Pub. No.: US 2017/0236232 A1
(43) Pub. Date: Aug. 17, 2017

(54) Integrated Security Inspection System

(71) Applicant: Rapiscan Systems, Inc., Torrance, CA (US)

(72) Inventor: Edward James Morton, Guildford (GB)

(21) Appl. No.: 15/408,737

(22) Filed: Jan. 18, 2017

Related U.S. Application Data
(60) Provisional application No. 62/280,321, filed on Jan. 19, 2016.

(51) Int. Cl. G06Q 50/26

(52) U.S. Cl. CPC G06Q 50/265

(57) ABSTRACT

A highly versatile and efficient integrated security inspection system that includes a plurality of security checkpoints wherein the process flow associated with said security checkpoints and the functionality and operation of screening devices deployed in said security checkpoints are controlled through a central processor. In an embodiment, the security supervisor can remotely manage the process flow across security checkpoints deployed across multiple sites in the real time. The system facilitates following differential security procedures for individuals across security checkpoints leading to high throughput with enhanced security.

### CROSS-REFERENCE

The present application relies on U.S. Provisional Patent Application No. 62/280,321, entitled “Integrated Security Inspection System” and filed on Jan. 19, 2016, for priority, which is herein incorporated by reference in its entirety.

### FIELD

The present specification generally relates to security systems and in particular, to an integrated security inspection system in which data processing rules and business process flows are generated and collected from individual security checkpoints and controlled through a central server.

### BACKGROUND

Locations must often be secured to ensure public safety and welfare. For example, places where there are large concentrations of people, such as airports or entertainment events, places that are of particular governmental importance, such as courthouses and government buildings, and other places where the threat of violence is high, such as prisons, require security measures to thwart dangerous or illegal activities. The primary security objective is to prevent the unauthorized entry of weapons, dangerous materials, illegal items, or other contraband into the location, thereby securing it. This is often achieved by requiring all people and items to enter into the location through defined checkpoints and, in those checkpoints, subjecting those people and items to thorough verification and searches.

Currently, various devices are used to perform such searches. Regardless of the place of use, these detection systems are employed to detect the presence of contraband on the body or luggage of individuals entering the secure area. Contraband is not limited to weapons and arms, but rather it includes explosives (fireworks, ammunition, sparklers, matches, gunpowder, signal flares); weapons (guns, swords, pepper sprays, martial arts weapons, knives); pressurized containers (hair sprays, insect repellant, oxygen/propane tanks); poisons (insecticides, pesticides, arsenic, cyanide); household items (flammable liquids, solvents, bleach); and corrosives (acids, lye, mercury).

The screening checkpoints used in current security systems predominately operate using a single input and single output line approach. Each item must be thoroughly and individually scanned in the conventional systems. The complex security protocols being instituted require individuals to have each of their belongings, including laptops, shoes, coats, mobile phones, keys and other items, scanned by an X-ray scanner. It takes a considerable amount of time for individuals to divest themselves of their belongings. Furthermore, passengers lack information regarding what items should be subjected to CT scanning, x-ray scanning, metal detection, or hand searching, such as large buckle belts or shoes. The presence of portable computing devices, such as laptops, further causes more delay. Portable computing devices must be removed from their carrying case and placed into bins or drawers so that they can be scanned singularly. Passengers often fail to efficiently remove such items from their carrying cases and, consequently, do not proceed through the scanning checkpoint efficiently. Individual passengers thus wait in line until they have access to the machine.

Contributing to the lag associated with the divestiture process, current systems employ a single conveyor belt, upon which each of the individual passenger items must be placed in order for the items to pass through the x-ray machine. Once the items are scanned, they accumulate on the opposite side of the scanning machine, thus creating “traffic” on the belt until retrieved by the passenger/owner. The belt must often be stopped by the operator to prevent the backlog of unclaimed baggage from reversing into the x-ray machine.

Further, the current security management systems are highly time consuming and inefficient as the various security checkpoints work in isolation and similar security procedures are followed for personnel passing through such security checkpoints. Usually, no distinction is made in security procedures based on the threat profile of an individual. For example, while using conventional systems, it is very difficult to exempt a specific section of people from following certain security procedures when the threat perception of that group is very low. There is no central control system to modify the process flow at individual security checkpoints and/or the scanning parameters of screening machines deployed at such checkpoints. The prior art recognizes the need for an integrated system which pulls together data from various independent screening machines and security checkpoints to generate a holistic risk analysis of a passenger. However, current technology does not provide a specific architecture detailing the structure, function and operation of such an integrated security inspection system. Further, the conventional security systems are not equipped to identify each passenger and/or evaluate his or her risk profile in the real time.

Current security systems comprise a number of security checkpoints such as check-in counters, custom clearance checkpoints and immigration counters at airports, metal detectors, x-ray scanners, personnel screening systems, baggage scanners, manual verification checkpoints, manual pat down checkpoints, staff entrance checkpoints, and goods entrance checkpoints at airports and other such secured locations. Generally, these security checkpoints and the screening devices deployed at such security checkpoints work in isolation such that the process flow followed by such checkpoints and the operational and functional parameters that govern the working of screening machines deployed at such checkpoints are defined and managed by local security staff deployed at respective security checkpoints. There is no centralized control in these security systems to modify the security procedures at specific locations or security checkpoints. In conventional systems, if the chief security officer of a large establishment such as a chain of hotels wants to modify the security procedures at a given set of security checkpoints in some specific hotel sites, he or she has to contact the security staff deployed at each individual hotel or set of security checkpoints and instruct them to modify the process flow and/or the scanning parameters of individual machines. A local security officer is in turn required to visit the physical location of the corresponding individual machines or security checkpoints and change the functional and operational parameters of each screening system individually. This process is very time consuming and it may not be possible to change the process flow with short notice.

There is need for an integrated security inspection system in which the data processing rules and business process flows are abstracted from the level of individual screening systems such that the operation of these systems is controlled from a centralized server.

There is also a need for integrated security inspection system in which the process flow associated with security checkpoints and the functionality and operation of screening devices deployed in said security checkpoints are controlled through a central server.

Additionally, there is a need for methods or systems of integrating data from multiple security devices dynamically and communicating such data to a plurality of users, in order to enable effective security.

Additionally, there is also a need for methods or systems of modifying security procedures and process flow across a set of security checkpoints or screening systems by issuing a simple computer instruction from a centralized system.

### SUMMARY

The following embodiments and aspects thereof are described and illustrated in conjunction with systems, tools and methods, which are meant to be exemplary and illustrative, not limiting in scope.

In some embodiments, the present specification discloses an integrated security inspection system comprising: a plurality of security checkpoints wherein at least one of said security checkpoints comprises at least one screening device; and, a central processor, remotely located from at least a portion of said plurality of security checkpoints and in data communication with said plurality of security checkpoints, wherein the central processor comprises at least one processor and memory and wherein said at least one processor is programmed to execute a plurality of programmatic instructions that, when executed, define at least one process flow and wherein said at least one process flow defines operational parameters for the at least one screening device.

Optionally, said at least one screening device may comprise at least one of: a metal detector, an ultrawide band imaging system, a millimeter wave imaging system, a terahertz imaging system, an X-ray screening system, a gamma ray detector, a neutron detector, a biometric scanner, an access card scanner, an ID card scanner, and/or a boarding pass scanner.

Optionally, the central processor is configured to modify said operational parameters by selecting a different process flow and issuing instructions from the central processor to the at least one screening device.

Optionally, the operational parameters of the at least one screening device are adapted to be modified by instructions issued from the central processor.

Optionally, said at least one processor is further programmed to execute a plurality of programmatic instructions that, when executed, repurposes the at least one screening device from screening passengers at an airport to scanning guests at a hotel.

Optionally, the central processor is in real time communication with each of the security checkpoints and the screening devices present in such security checkpoints.

Optionally, said at least one processor is further programmed to execute a plurality of programmatic instructions that, when executed, define a security procedure to be performed by the at least one screening device and wherein said at least one screening device is configured to receive and execute said security procedure.

Optionally, said at least one processor is further programmed to execute a plurality of programmatic instructions that, when executed, create a risk profile of an individual passing through said integrated security inspection system and, based on said risk profile, select a specific screening level for said individual from a set of predefined screening levels. Optionally, each of said screening levels represents a specific set of security procedures to be followed for said individual. Still optionally, based on said selected screening level, said at least one processor is further programmed to execute a plurality of programmatic instructions that, when executed, send instructions regarding the security procedure to be followed for said individual to the respective security checkpoints and/or screening devices.

Optionally, said at least one processor is further programmed to execute a plurality of programmatic instructions set by a security supervisor that, when executed, defines the security procedures to be followed for a specific set of people.

Optionally, said security system is implemented in the form of a computer program. Optionally, said computer program resides on a separate computing device. Still optionally, said computer program resides on one of the screening devices present in the security system. Still optionally, said computer program resides on an X-ray system.

Optionally, said central processor is coupled to a database to store the data captured by screening machines deployed at said security checkpoints.

Optionally, said at least one processor is further programmed to execute a plurality of programmatic instructions that, when executed, defines a security procedure corresponding to the identification details of an individual arriving at a specific security checkpoint shared in real time with said central processor.

Optionally, said at least one processor is further programmed to execute a plurality of programmatic instructions that, when executed, receive data indicative of individuals passing through the integrated security system and generate a risk profile for each of said individuals.

Optionally, said security system is coupled to an OPC (Open Platform Communication) interface to enable a two-way communication with other industrial devices and systems.

Optionally, said security system is deployed at an airport and said security checkpoints comprise entry gates, check-in counters, boarding pass issuing machines, X-ray screening checkpoints, metal detector checkpoints, baggage screening checkpoints, immigration counters, manual verification checkpoints, manual pat down checkpoints, staff entrance checkpoints, crew entrance checkpoints, goods entrance checkpoints, custom clearance checkpoints.

Optionally, one of said plurality of security checkpoints is located at a hotel and wherein said at least one processor is further programmed to execute a plurality of programmatic instructions that, when executed, receives data indicative of staff member and guest screenings, processes said data to determine a threat level and, based upon said determination, instructs individuals to divest objects.

Optionally, one of said plurality of security checkpoints is located at an airport and wherein said at least one processor is further programmed to execute a plurality of programmatic instructions that, when executed, receives data indicative of passenger screenings, processes said data to determine a threat level and, based upon said determination, directs passengers to a manual pat down search or allows passengers to proceed to board an aircraft.

Optionally, said central processor is deployed at a remote location.

In some embodiments, the present specification discloses an integrated security inspection system comprising: a first security checkpoint wherein said first security checkpoint comprises a first screening device; a second security checkpoint wherein said second security checkpoint comprises a second screening device, wherein said first security checkpoint is remote from said second security checkpoint; a third security checkpoint wherein said third security checkpoint comprises a third screening device, wherein said third security checkpoint is remote from both said first and second security checkpoint; a first local hub wherein the first local hub is configured to control a process flow associated with each of said first security checkpoint and its first screening device and said second security checkpoint and its second screening device; and, a second local hub wherein the second local hub is configured to control a process flow associated with said third security checkpoint and its third screening device, wherein said second local hub is located remote from the first local hub; and a master hub which is configured to control each of said first local hub and second local hub.

Optionally, said local hubs and said master hub have processing capability. Optionally, each said local hub is in real time data communication with the subset of security checkpoints that are controlled by said local hub. Optionally, said master hub is in real time data communication with said plurality of local hubs.

Optionally, each of said first, second, and third screening device may comprise at least one of: a metal detector, an ultrawide band imaging system, a millimeter wave imaging system, a terahertz imaging system, an X-ray screening system, a gamma ray detector, a neutron detector, a biometric scanner, an access card scanner, an ID card scanner, and a boarding pass scanner.

Optionally, said security system is deployed across multiple hotel sites and wherein each of said local hubs controls a plurality of security checkpoints deployed at a specific hotel site, wherein one of said plurality of security checkpoints is located at a staff entrance and wherein said at least one processor is further programmed to execute a plurality of programmatic instructions that, when executed, receives data indicative of a staff member access card, processes said data to determine a threat level and, based upon said determination, allows an employee to enter the hotel site or subjects the employee to manual verification and search.

Optionally, said security system is deployed across multiple hotel sites and wherein each of said local hubs controls a plurality of security checkpoints deployed at a specific hotel site, wherein one of said plurality of security checkpoints is located at a guest entrance and wherein said at least one processor is further programmed to execute a plurality of programmatic instructions that, when executed, receives data indicative of a guest metal detector screening, processes said data to determine a threat level and, based upon said determination, allows said guest to enter the hotel site or subjects the guest to a manual search.

Optionally, said security system is deployed across multiple hotel sites and wherein each of said local hubs controls a plurality of security checkpoints deployed at a specific hotel site, wherein one of said plurality of security checkpoints is located at a goods entrance and wherein said at least one processor is further programmed to execute a plurality of programmatic instructions that, when executed, receives data indicative of a goods X-ray screening, processes said data to determine a threat level and, based upon said determination, clears the goods to enter the hotel site or subjects the goods to a manual search.

Optionally, said master hub and said local hubs are configured to issue instructions to modify the process flow corresponding to any specific security checkpoint.

Optionally, said master hub and said local hubs are configured to issue instructions to modify the functional and operational parameters corresponding to any screening device deployed in the said security system.

Optionally, the security procedures to be followed at any security checkpoint are defined at the level of the corresponding local hub or the master hub and said master hub and said local hubs are configured to issue instructions to direct the screening machines and/or personnel deployed at such security checkpoints to follow the defined procedures.

Optionally, the integrated security inspection system is configured to create a risk profile of an individual passing through said integrated security inspection system and, based on said risk profile, select a specific screening level for said individual from a set of predefined screening levels.

Optionally, each of said screening levels represents a specific set of security procedures to be followed for said individual.

Optionally, based on said selected screening level, the local hub and/or master hub are configured to send instructions regarding the security procedures to be followed for said individual to the respective security checkpoints and/or screening devices.

Optionally, said master hub and/or said local hubs are configured to follow security procedures for a specific group of people set by a security supervisor.

Optionally, said local hub and master hub are coupled to separate databases to store the data captured by screening machines deployed at said security checkpoints.

Optionally, the identification details of an individual arriving at a specific security checkpoint are shared in real time with the local hub and/or the master hub which provides a corresponding security procedure to be followed for the said individual.

Optionally, said master hub is coupled to external systems and databases to access details of people passing through said security system to create their risk profile.

Optionally, said security system is coupled to an OPC (Open Platform Communication) interface to enable a two-way communication with other industrial devices and systems.

In some embodiments, the present specification discloses a method of screening an individual or object comprising the steps of: providing an integrated security inspection system comprising: a plurality of security checkpoints wherein at least one of said security checkpoints comprises at least one screening device; and a central processor, remotely located from at least a portion of said plurality of security checkpoints and in data communication with said plurality of security checkpoints, wherein the central processor comprises at least one processor and memory and wherein said at least one processor is programmed to execute a plurality of programmatic instructions that, when executed, define at least one process flow and wherein said at least one process flow defines operational parameters for the at least one screening device; screening said individual or object using a first screening device to generate a threat level associated with said individual or object; and advancing said individual or object to additional screening devices and/or security checkpoints for further screening or allowing said individual or object to pass said integrated security inspection system based on said generated threat level.

In some embodiments, the present specification discloses a method of screening individuals or objects comprising the steps of: providing an integrated security inspection system comprising: a first security checkpoint wherein said first security checkpoint comprises a first screening device; a second security checkpoint wherein said second security checkpoint comprises a second screening device, wherein said first security checkpoint is remote from said second security checkpoint; a third security checkpoint wherein said third security checkpoint comprises a third screening device, wherein said third security checkpoint is remote from both said first and second security checkpoint; a first local hub wherein the first local hub is configured to control a process flow associated with each of said first security checkpoint and its first screening device and said second security checkpoint and its second screening device; and, a second local hub wherein the second local hub is configured to control a process flow associated with said third security checkpoint and its third screening device, wherein said second local hub is located remote from the first local hub; and a master hub which is configured to control each of said first local hub and second local hub; screening said individual or object using said first screening device to generate a threat level associated with said individual or object; and advancing said individual or object to additional screening devices and/or security checkpoints for further screening or allowing said individual or object to pass said integrated security inspection system based on said generated threat level.

In some embodiments, the present specification discloses an integrated security inspection system comprising: a plurality of security checkpoints wherein at least one of said security checkpoints comprises at least one screening device; and, a central processor in data communication with said screening devices and/or a computing system deployed at such security checkpoints, wherein the process flow associated with said security checkpoints and the functionality and operation of screening devices deployed in said security checkpoints are controlled through said central processor.

Optionally, said screening device may comprise at least one of: a metal detector, an ultrawide band imaging system, a millimeter wave imaging system, a terahertz imaging system, an X-ray screening system, a gamma ray detector, a neutron detector, a biometric scanner, an access card scanner, an ID card scanner, and/or a boarding pass scanner.

In some embodiments, the present specification discloses an integrated security inspection system comprising: a plurality of security checkpoints wherein at least one of said security checkpoints comprise at least one screening device; a plurality of local hubs wherein each of said local hubs is configured to control the process flow associated with a subset of said security checkpoints and the functionality and operation of screening devices deployed in said subset of security checkpoints; and, a master hub which is configured to control said plurality of local hubs.

The aforementioned and other embodiments of the present specification shall be described in greater depth in the drawings and detailed description provided below.

### BRIEF DESCRIPTION OF THE DRAWINGS

These and other features and advantages of the present specification will be appreciated, as they become better understood by reference to the following detailed description when considered in connection with the accompanying drawings, wherein:

FIG. 1 is a block diagram illustrating a top level architecture of an integrated security system in accordance with an embodiment of the present specification;

FIG. 2 is a block diagram showing a detailed architecture of an integrated security system highlighting various components and the data flow between such components in accordance with an embodiment of the present specification;

FIG. 3A is a flow diagram describing a process flow associated with a conventional airport security system;

FIG. 3B is a flow diagram describing a process flow associated with an integrated airport security system, in accordance with an embodiment of the present specification;

FIG. 4A illustrates an architecture of an integrated security inspection system deployed at an airport in accordance with an embodiment of the present specification;

FIG. 4B is a flow diagram describing a process flow of the integrated security inspection system deployed at an airport, as shown in FIG. 4A, in accordance with an embodiment of the present specification;

FIG. 5 is an exemplary table showing various screening levels and associated security procedures in accordance with an embodiment of the present specification;

FIG. 6 is a flow diagram illustrating a process flow at a security checkpoint managed in accordance with an embodiment of the present specification;

FIG. 7 is a flow diagram of a process flow at a specific security checkpoint managed in accordance with another embodiment of the present specification;

FIG. 8A is a flow diagram illustrating a process flow at a screening checkpoint where passengers having a specific class of ticket are exempted from certain security procedures;

FIG. 8B is a flow diagram illustrating a process flow at a screening checkpoint where none of the passengers is exempted from following specific security procedures;

FIG. 9 is a block diagram illustrating the architecture of an integrated security inspection system deployed at a hotel in accordance with an embodiment of the present specification;

FIG. 10 is a block diagram illustrating the architecture of an integrated security inspection system that is deployed across multiple hotel sites in accordance with an embodiment of the present specification;

FIG. 11A is a flow diagram illustrating an exemplary process flow at a goods entrance checkpoint when the threat level is classified as low;

FIG. 11B is a flow diagram illustrating an exemplary process flow at a goods entrance checkpoint when the threat level is classified as high;

FIG. 12A is a flow diagram illustrating an exemplary process flow at a guest entrance checkpoint when the threat level is classified as low;

FIG. 12B is a flow diagram illustrating an exemplary process flow at a guest entrance checkpoint when the threat level is classified as high;

FIG. 13A is a flow diagram illustrating an exemplary process flow at a staff entrance checkpoint when the threat level is classified as low; and

FIG. 13B is a flow diagram illustrating an exemplary process flow at a staff entrance checkpoint when the threat level is classified as high.

### DETAILED DESCRIPTION

The present specification describes an integrated security inspection system that is efficient, scalable and highly versatile compared to existing security systems. In embodiments of the present specification, the rules and definitions that govern the functionality of multiple individual screening systems that may be present in the integrated security system are controlled through a centralized system. In embodiments of the present specification, the data processing rules and business process flows are abstracted from the level of individual screening machines such that the operation of these machines is controlled from a centralized server. In embodiments, the various security procedures to be followed at specific security checkpoints are dynamically defined at a central level and the screening systems and personnel deployed at corresponding security checkpoints are accordingly instructed to follow such defined procedures. In embodiments of the present specification, the centralized server can be used to set the functional and operational parameters that govern the use of various screening devices in the integrated security system. In an embodiment, the centralized server also controls the utilization of individual screening devices such that these devices can be repurposed from one type of use to another type of use depending on the business requirement. For examples, devices configured to screen passengers at an airport can be repurposed to scan guests at a hotel.

In embodiments, the various security checkpoints and the corresponding screening systems deployed at the security checkpoints are in real time data communication with the centralized control system such that a holistic risk profile of a subject passing through multiple security checkpoints can be created. Thus, security protocols to be followed at various security checkpoints can be dynamically modified via the centralized control system. In embodiments, the various security checkpoints and the corresponding screening devices deployed at the security checkpoints function as mere data capturing sites and the entire data related to a subject is transmitted to the centralized control system for processing and decision making. In alternate embodiments, the data captured by the individual screening machines can be processed jointly at the levels of individual security checkpoints and the centralized control system.

In an embodiment, the architecture of the integrated security system of the present specification comprises a tiered structure. In an embodiment, the tiered architecture of present specification comprises multiple local security hubs coupled to a master security hub that controls the entire security system. In an embodiment, each of the local security hubs of the present specification is coupled to one or more security checkpoints wherein each such security checkpoint comprises one or more screening devices deployed at such checkpoint. In an embodiment, the various screening devices and equipment deployed at each security checkpoint are configured to function in accordance with the instructions received from the local security hubs. In an embodiment, each of the local security hub functions as a first level control system and the security personnel in charge of the local security hub can define the security procedures and business processing rules to be followed by one or more screening machines that fall under the control of the local security hub. In embodiments, the master security hub functions as a second level control system such that the various local security hubs and the corresponding security checkpoints that fall under the ambit of the local security hubs can be controlled by the security personnel in charge of the master security hub. In various embodiments, the hubs are located remote from one another, wherein remote is defined as a situation in which two checkpoints, hubs, or other systems are not within sight of each other and can therefore not be physically staffed by the same personnel. Two checkpoints or hubs may be remote from each other even if they are in the same hotel, for example.

In an embodiment, the integrated security system of the present specification is implemented in the form of a computer program such that the various local security hubs and the master security hub are computer applications that reside in one or more computer systems. In an embodiment, instead of a deploying a separate computing infrastructure, the computer applications representing any local security hub are embedded in one or more screening machines (such as an X-ray machine) which are under the control of such local security hub. In an embodiment, the computer application representing the master security hub is embedded in an independent computing system that is controlled by the concerned security in-charge.

In some embodiments, the system of the present specification may be employed with any screening system, machine or device. The system of the present specification is agnostic to the type of device employed and is capable of using a centralized control system to control any number of devices employed and receive and transmit data from any number or type of device employed. For example, but not limited to such example, the screening system may comprise at least one of: a metal detector, an X-ray scanning system, an ultra-wide band imaging and detection system, a millimeter wave imaging system, a terahertz imaging system, a gamma ray detector, a neutron detector, a biometric scanner, an access card scanner, an ID card scanner, and/or a boarding pass scanner. It should be noted herein that the number of and/or types of screening systems delineated in the present specification and examples below are by way of example only and that any screening system can be employed with the centralized architecture and methods of the present specification.

U.S. patent application Ser. Nos. 14/944,067, 14/859,647, 14/531,485, 14/293,233, 14/280,774, 14/149,473, 14/104,508, 13/942,563, 13/903,598, 13/365,114, 13/175,785, 12/887,510, and 12/643,021 and U.S. Pat. Nos. 9,182,516, 8,995,619, 8,774,362, 8,766,764, 8,654,922, 8,638,904, 8,576,982, 8,199,996, 8,135,112, 7,826,589, 7,796,733, 7,660,388, and 7,418,077 all disclose people screening systems and are all incorporated herein by reference in their entirety. U.S. Pat. Nos. 7,660,388 and 7,418,077, also both assigned to the applicant of the present specification and incorporated herein by reference in their entirety, disclose passenger screening stations which can be used with the intelligent screening systems and methods disclosed herein.

It should further be appreciated that all of the processes disclosed herein are effectuated by at least one processor, located in one or more of the central machines or screening machines, in data communication with at least one memory which stores a plurality of computer programs, as described herein. In each case, processes described below shall be understood to be achieved by a processor executing a plurality of programmatic instructions. It should further be appreciated that the output of the processes described herein is the clearance or flagging of an individual being screened.

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

It should be noted herein that any feature or component described in association with a specific embodiment may be used and implemented with any other embodiment unless clearly indicated otherwise.

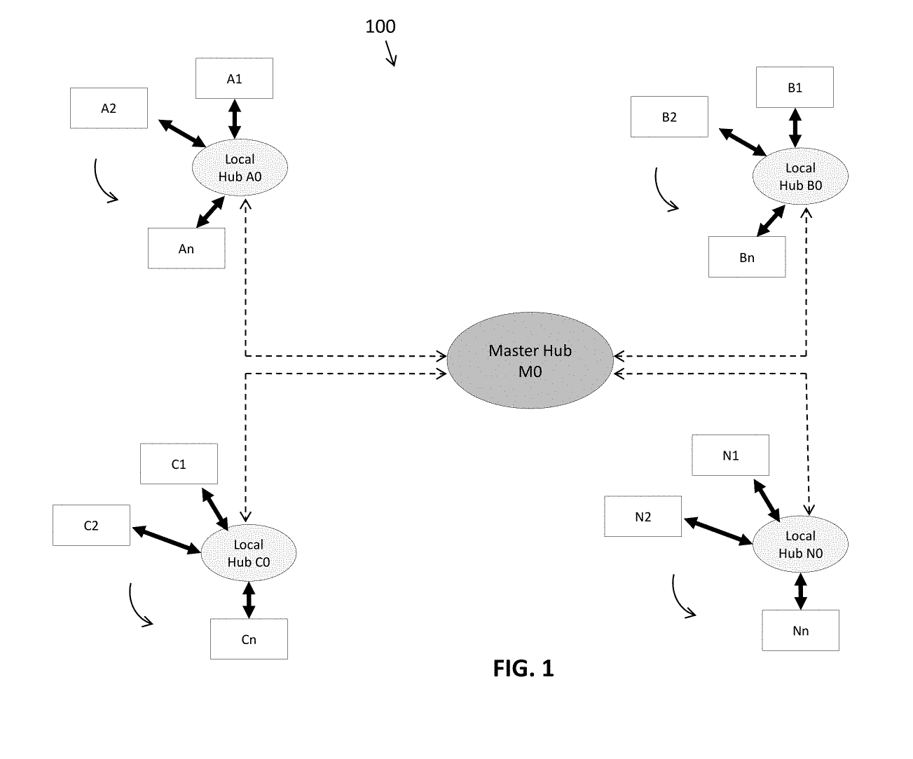

FIG. 1 illustrates a top level architecture of an integrated security system in accordance with an embodiment of the present specification. In FIG. 1, the security system 100 comprises a plurality of local security hubs A₀, B₀, C₀, . . . N₀ coupled to a master security hub M₀. In embodiments, the master security hub M₀ is in real time data communication with the local security hubs A₀, B₀, C₀, . . . N₀. In an embodiment, each of the local security hubs controls one or more security checkpoints wherein at least one of such security checkpoints comprise one or more screening devices such as, but not limited to, an X-ray screening machine, a metal detector, a millimeter wave imaging device, an ultrawide band detection system, a terahertz imaging device, a baggage screening machine, and/or a biometric scanner. In FIG. 1, the local security hub A₀ is coupled to screening machines A₁, A₂, . . . Aₙ. Similarly, the local security hub B₀ is coupled to screening machines B₁, B₂, . . . Bₙ, the local security hub C₀ is coupled to screening machines C₁, C₂, . . . Cₙ and the local security hub N₀ is coupled to screening machines N₁, N₂, . . . Nₙ and so forth. In embodiments, the integrated security system of the present specification comprises one or more local hubs such that the number N≧1 (at least one local hub). In embodiments, the at least one of the local security hubs is coupled to one or more screening machines such that the number n≧1 (at least one screening machine). In embodiments, a single local hub deployed at a large secured establishment may be coupled to a hundred screening machines comprising a plurality of individual detection systems such as X-ray detectors and metal detectors. In an alternate embodiment, a single local hub deployed at a small establishment may be coupled to a single screening machine. In an embodiment, the local hub does not comprise any screening machine such as in the case of a local hub corresponding to a manual verification checkpoint. In embodiments, there is only a single local hub while in alternate embodiments specifically configured for large security establishments, there may be over a thousand local hubs controlled by a one or more master hubs. One of ordinary skill in the art would appreciate that the number of local hubs controlled by a master hub and the number of screening machines controlled by any local hub can vary without departing from the spirit and scope of the present specification.

In embodiments, each local security hub is in real time data communication with the various screening machines coupled to the respective security hub. In embodiments, the various devices and the security hubs are coupled through wireless networks.

While FIG. 1 describes a two-tiered security architecture comprising a first level control layer represented by a master hub and a second level control layer represented by one or more individual local hubs, in alternate embodiments, the integrated security system of the present specification can be configured to have more than two levels of control layers.

In an embodiment of the present specification, a centralized control system is used to dynamically modify the security procedures to be followed for a specific person or object at any security checkpoint. In an embodiment of the present specification comprising an integrated security system deployed at a transit point such as an airport or railway station, a centralized control system is used to analyze and determine the threat level associated with a passenger or a class of passengers and based on the determined threat level, the individual security checkpoints are instructed to follow specific security procedures. In some embodiments, the individual security checkpoints may include, among others, check-in counters, immigration counters, X-ray screening systems, baggage screening systems, metal detector systems, and manual pat down search operators. For example, if the threat level is observed to be low on a given day, the centralized control system is used to instruct the various security checkpoints to follow relatively more accommodative screening rules for all passengers. Similarly, in another exemplary illustration, if the threat level associated with a specific person is observed to be high on a given day, the centralized control system is used to instruct the various security checkpoints to follow relatively strict screening protocols for that specific person. In an embodiment, various parameters such as, but not limited to, passenger information, date, type of ticket, and destination are analyzed to create a risk profile of the passenger and based on such risk profile, specific screening procedures are selected for an individual.

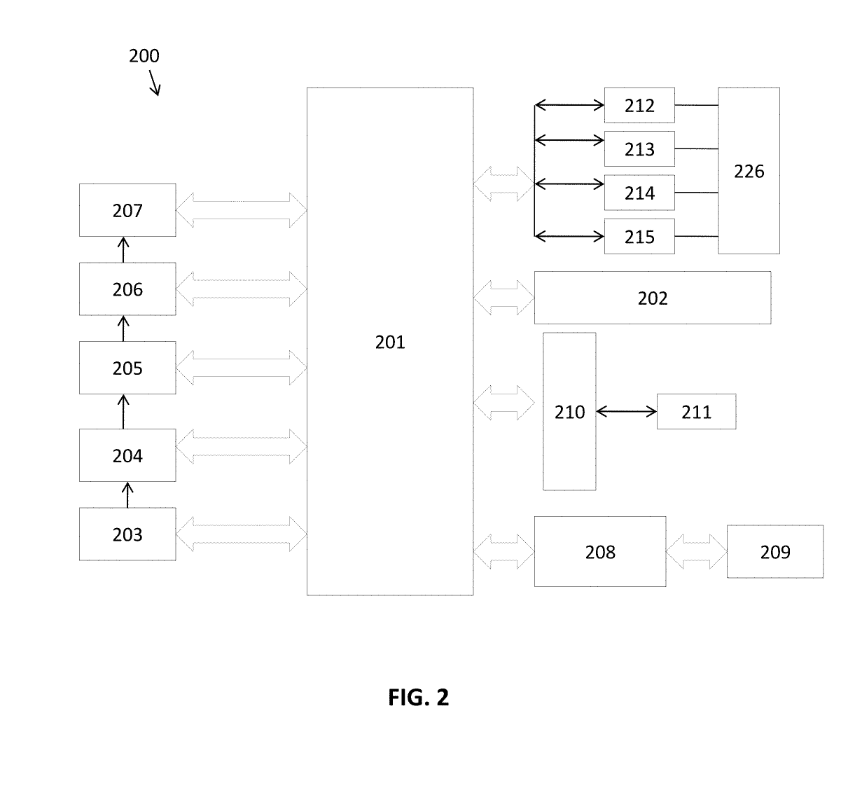

While FIG. 1 describes a high level architecture of the integrated security system of the present specification, FIG. 2 describes a detailed architecture of an integrated security system comprising various components and the data flow and interconnections between the components, in accordance with an embodiment of the present specification. As shown in FIG. 2, the integrated security inspection system 200 comprises various scanning systems and modules which are coupled through a data bus such as, but not limited to, enterprise services bus (ESB) 201. In an embodiment, the present specification describes a system in which the entire security platform is controlled at a central level through an engine or processor that controls the complete process flow as well as the rules that govern the operation of all individual machines and sub-systems that are part of the integrated security system 200. In an embodiment, the integrated security system 200 abstracts inspection processing rules and business process flows from the level of individual screening machines and controls the operation of the integrated security system through a central processor 202. In an embodiment, the central processor or rule engine 202 comprises various rules and algorithms that define the operation of integrated security system 200. In embodiments, the rule engine 202 has the processing capability to control the various modules in security system 200.

In embodiments, the integrated security system 200 comprises various sub-systems or machines that are equipped to detect spurious substances and/or suspicious activity. In an embodiment, the integrated security system 200 comprises a metal detection system 212, an X-ray system 213, a trace detector 214 and a bar code reader 215 which are all networked with the other components of the integrated security system 200 through a common enterprise data bus 201. In an embodiment, the various screening machines such as the metal detection system 212, X-ray system 213, trace detector 214, bar code reader 215 are coupled to a cyber interface 226 that secures these devices from external threats. One of ordinary skill in the art would appreciate that the present embodiment is described with only one metal detection system, one X-ray system, one a trace detection system and one bar code reader only for the ease of illustration. In alternate embodiments of the present specification, actual integrated security inspection system comprises a wide variety and number of screening machines depending on security requirements of the establishment in which such security system is deployed. In embodiments, the various sub-systems or machines present in the integrated security inspection system 200 are equipped to conduct a two-way communication with other components of the integrated security system 200 and with any other external devices and systems through the enterprise data bus 201.

In an embodiment, the system 200 comprises a data acquisition module 203, an image processing module 204, a threat detection module 205, a visualization module 206 and a display module 207. In an embodiment, the data acquisition module 203 is configured to receive data gathered by various scanning machines such as the metal detection system 212, an X-ray system 213, a trace detector 214 and a bar code reader 215 through the enterprise services bus 101. In alternate embodiments, the data acquisition module 203 is also equipped to receive data from any external devices and systems. The data acquisition module 203 is coupled to the image processing module 204 that processes the data gathered by the data acquisition module 203 and generates corresponding imaging information. In embodiments, the image processing module 204 is coupled to a threat detection module 205 which analyzes the information received from image processing module 204 to detect and qualify any type of threat perception contained within the received information. In an embodiment, the threat detection module 205 is coupled to a visualization module 206 that processes the data received from threat detection module 205 and generates visual images of an object or person that is being scanned along with reports showing the threat level associated with such object or person. In an embodiment, the visualization module 206 is coupled to a display module 207, which processes the information received from visualization module 206 and displays it on a screen.

In embodiments, each of the modules such as the image processing module 204, threat detection module 205, visualization module 206 and display module 207 is also in direct data communication with enterprise services bus 201 and can directly exchange information with any other component of the security inspection system 200.

In embodiments, the security inspection system 200 is coupled to an Open Platform Communication (OPC) interface 208 to enable a two-way communication with other industrial devices and systems. In an embodiment, the OPC interface 208 is further coupled to a supervisory control and data acquisition (SCADA) interface 209.

In embodiments, the security inspection system 200 is implemented in the form of a computer program and the modules such as the rules engine 202, data acquisition module 203, image processing module 204, threat detection module 205, visualization module 206 and display module 207 are computer programs. In an embodiment, the various computer applications pertaining to the security system 200 reside within one or more screening systems such as the X-ray screening machine. In an alternate embodiment, the various computer applications associated with the security system 200 reside in an independent computing platform comprising a processing system and a memory module.

In an embodiment, the integrated security system 200 comprises a web server 210 that is further coupled to a user interface 211. In embodiments, the user interface 211 is a graphical user interface and provides a platform to the user to monitor and control the system 200. In an embodiment, the user can control every single unit or machine in the security system 200 through the user interface 211. In embodiments, the user interface 211 is also used for outputting various types of relevant information to a user.

In an embodiment, the integrated security system of the present specification is configured such that the various security procedures to be followed at any security checkpoints are determined at a central level and the equipment/machine deployed at each security checkpoint is accordingly instructed to follow the selected security procedures. In an embodiment of the present specification, the threat level associated with any person entering a secure area is analyzed and based on such threat level the security procedures to be followed for security clearance of said individual are determined and communicated to the corresponding security checkpoints.

In an embodiment, the integrated security system of the present specification is a computer program that is compatible with various commercially available screening machines that are used at security checkpoints. In an embodiment, the user is required to install the computer program of the present specification on a computing device linked to a network interface subsequent to which all the compatible screening devices, which are linked via the network interface, can be directly controlled by the interface provided by such computer program.

In embodiments, the deployment of the integrated security inspection system of the present specification enhances the efficiency, strength and versatility of the overall security arrangement of a location. In embodiments, the integrated security inspection system of the present specification is deployed at various types of security establishments such as, but not limited to airports, railway stations, seaports, hotels, offices, and commercial buildings. The subsequent sections of the present specification describe various business process flows associated with specific security establishments that highlight how the deployment of integrated security inspection system of the present specification improves the security arrangement of a location and are presented by way of example only.

### Integrated Airport Security Inspection System

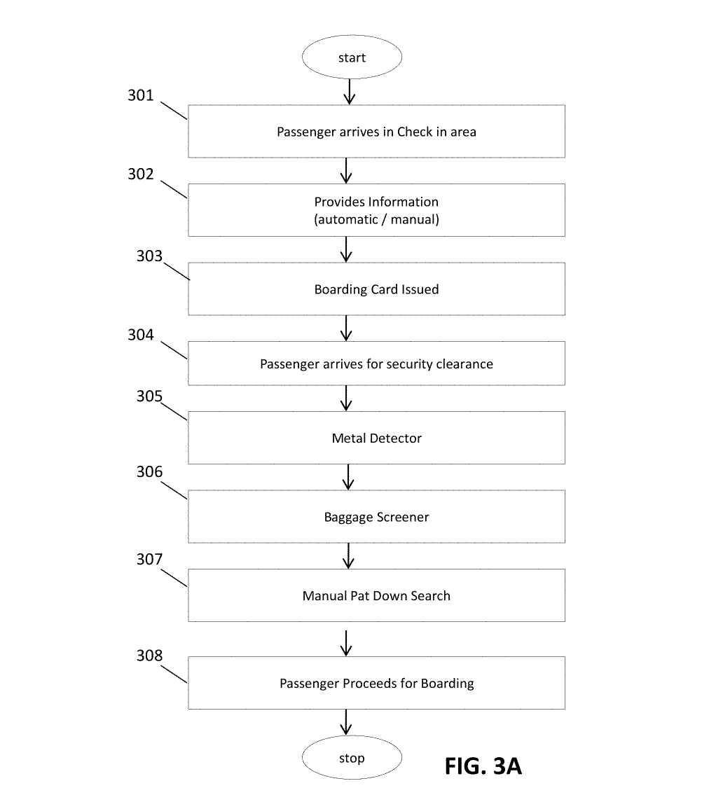

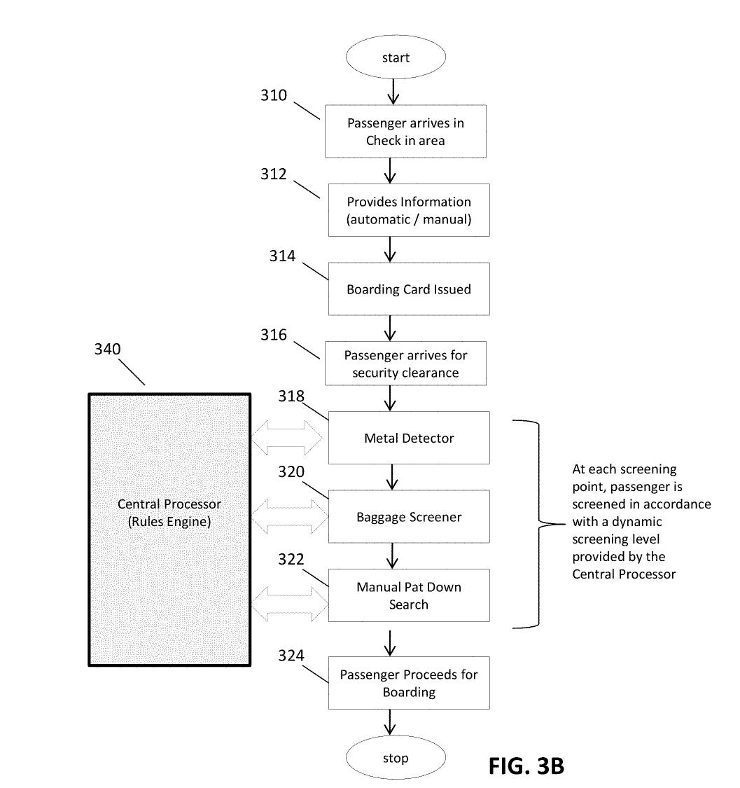

FIG. 3A illustrates a flow chart that describes the conventional process flow associated with an airport security system. As shown in FIG. 3A, at step 301, the passenger arrives in the check-in area of the airport. At step 302, the passenger provides his information (travel ticket, identification). In an embodiment, the passenger has the option to provide this information either through an automatic machine that issues the boarding pass or to an airline executive who feeds the information into a database on behalf of the passenger and issues the boarding pass as shown in step 303. At step 304, the passenger proceeds for security clearance. Typically, at an airport, the passengers are required to pass through a metal detector as shown in step 305. In addition, the hand baggage of a passenger is screened with X-ray machine or other such scanning systems as shown in step 306. Usually, the passengers are also required to remove their laptop and other such devices from the hand baggage and keep it in a tray that is separately scanned. At step 307, the passengers are subject to manual pat down search. In case no abnormality is found in above security checkpoints, the passengers can proceed for aircraft boarding as shown in step 308. One of ordinary skill in the art can appreciate that irrespective of the risk profile of an individual as similar procedures are followed for all the passengers, the above security procedures consume a lot of time. Sometimes, the security personnel deployed at various checkpoints such as at a metal detector and/or manual pat down screening use their discretion to ask specific passengers to follow certain divestiture procedures such as removal of shoes/jackets/personal belongings for detailed examination. In case the overall threat perception is high, all the passengers may be asked to follow such procedures which consumes a lot of time and compromises with the efficiency of security clearance process.

As the individual security checkpoints work in isolation, similar security procedures are followed for most of the passengers. In addition, screening checkpoints used in current security systems predominately operate using a single input and single output line approach. Each item must be thoroughly and individually scanned in the conventional systems. The complex security protocols being instituted require individuals to have each of their belongings, including laptops, shoes, coats, mobile phones, keys and other items, scanned by an X-ray scanner. It takes a considerable amount of time for individuals to divest themselves of their belongings and to remove laptops from their cases. This divestiture process tends to happen serially with individuals waiting in line until they have access to the machine. Contributing to the lag associated with the divestiture process, current systems employ a single conveyor belt, upon which each of the individual passenger items must be placed in order for the items to pass through the x-ray machine. Once the items are scanned, they accumulate on the opposite side of the scanning machine, thus creating “traffic” on the belt until retrieved by the passenger/owner. The belt must often be stopped by the operator to prevent the backlog of unclaimed baggage from reversing into the x-ray machine.

FIG. 3B illustrates a flow chart that describes a process flow associated with an integrated airport security system in accordance with an embodiment of the present specification. As shown in FIG. 3B, at step 310, the passenger arrives in the check-in area of the airport. At step 312, the passenger provides his information (travel ticket, identification) and a boarding pass is issued to the passenger as shown in step 314. At step 316, the passenger proceeds for security clearance. In an embodiment of the present specification, various data processing and process flow rules are abstracted from the level of individual security checkpoints such as the metal detector, x-ray scanner, or via manual pat down screening and a central rules based engine such as the central processor 340 analyzes various parameters to determine the specific security procedures to be followed for each specific passenger. Various security checkpoints such as the metal detector and/or baggage scanner are in dynamic data communication with the central processor 340. In an embodiment of the present specification, as the passenger arrives for metal detector screening at step 318, he or she is screened as per the security procedures communicated by the central processor 340. In an embodiment, the central processor 340 analyzes various parameters such as the passenger data, type of ticket, date, destination, airline and other such parameters to determine the security procedures to be followed for each individual and accordingly the specific individual is subjected to such security procedures. In an embodiment, in case the perceived threat level associated with an individual is high, he or she may be asked to remove his jacket, shoes, mobile phones and/or personal belongings while passing through metal detector at step 318. In an alternate embodiment, in case the perceived threat level is low, the individual may be asked to completely by-pass the metal detector screening. Similarly, at steps 320 and 322, the baggage screening and manual pat-down search are also done as per the instructions communicated by the central processor 340. In an embodiment, the security procedures are communicated in the form of screening levels wherein each screening level provides a specific set of security protocols that are to be followed. At step 324, the passenger proceeds for aircraft boarding. As all the passengers are not required to undergo similar level of detailed investigation at various security checkpoints, the integrated security system described in the present specification improves the overall system efficiency and reduces the waiting time for passengers. Further, in an embodiment, in case the security in-charge wants to increase the throughput on any given day he can simply change the process flow by sending commands from a central server to all the relevant security checkpoints to bypass certain procedures that can be avoided based on the threat perception. Unlike conventional security systems, in embodiments of the present specification, the process flow associated with various security checkpoints is highly flexible and can be modified by issuing single command from a remote computer system.

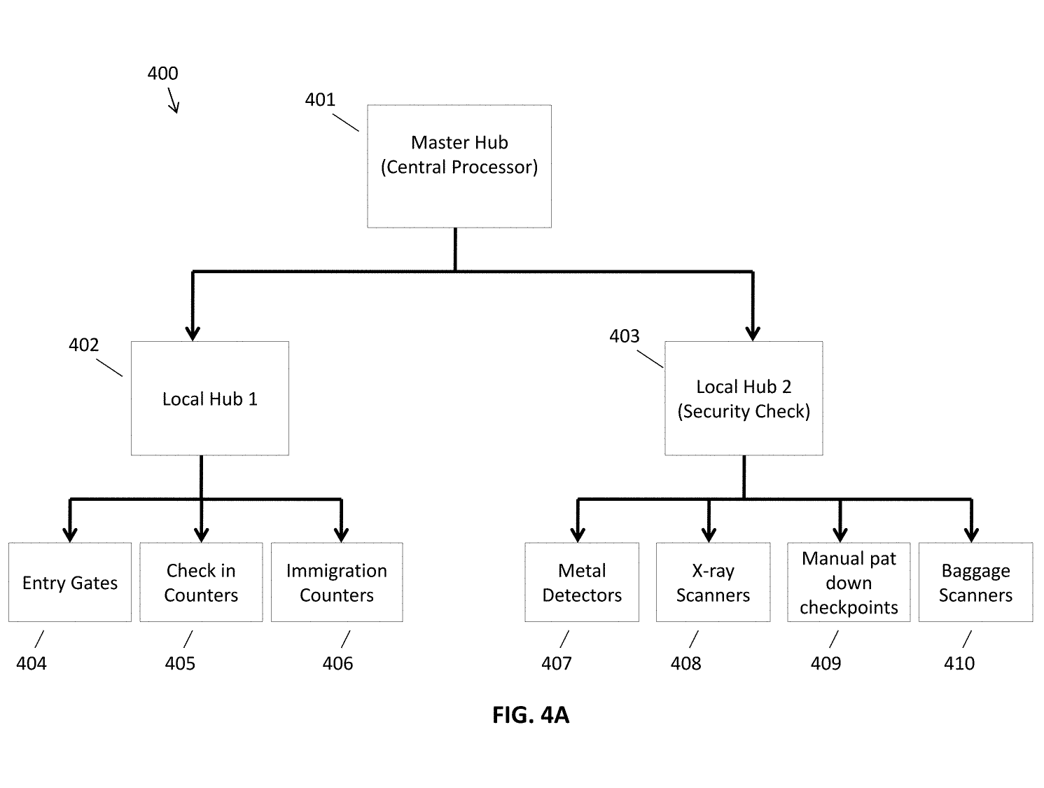

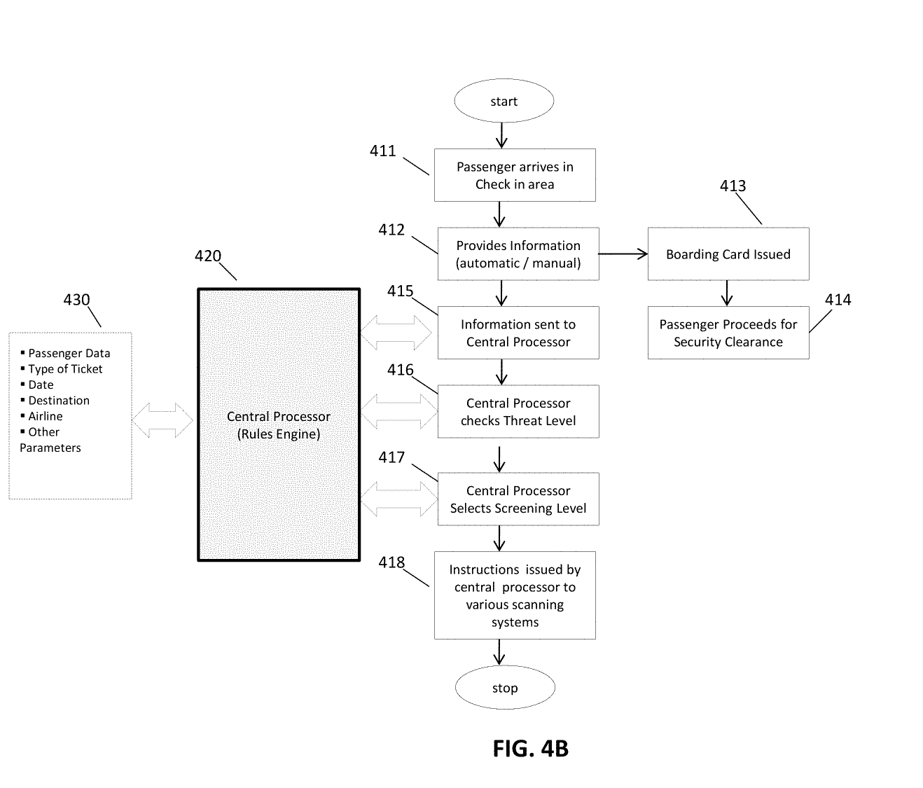

FIG. 4A illustrates an architecture of an integrated security inspection system deployed at an airport, in accordance with an embodiment of the present specification. As shown in FIG. 4A, in an embodiment, the integrated security system 400 comprises a master control hub 401 that is coupled to two local control hubs 402 and 403 such that each of these local hubs is coupled to multiple security checkpoints 404-410. In embodiments, the control hubs, security checkpoints and the screening machines deployed at any such checkpoints are coupled to a common network that enables them to exchange data with each other. In an embodiment, the master control hub 401 and the local control hubs 402 and 403 have processing capability.

In an embodiment, the local hub 402 is coupled to various security checkpoints such as the entry gates 404, check-in counters 405 and immigration counters 405. The checkpoints such as entry gates 404, check-in counters 405 and immigration counters 405 are managed by security staff who feed or input any information related to the passenger passing through the checkpoint, such as, but not limited to, passenger identity information, travel information and other related or relevant information into a data entry and/or computing unit deployed at such checkpoints. In an embodiment, the local hub 403 is coupled to one or more screening devices and manual search and verification checkpoints deployed for the security clearance. In an embodiment, the local hub 403 is coupled to metal detector system 407, an X-ray scanner 408, a check in baggage scanner 410 and a manual pat down checkpoint 409. In an embodiment, each of the security checkpoints such as metal detector 407, x-ray scanner 408, baggage scanner 410 and manual pat down checkpoint 409 represent multiple such screening devices and checkpoints, which are deployed at different locations on the airport. In an embodiment, the data captured by screening devices at such checkpoints is transmitted to the local hub 403 for analysis.

In an embodiment, the security checkpoints such as entry gates 404, check-in counters 405, and immigration counters 406 are controlled by local hub 402 such that the security supervisor controlling the local hub 402 can set operational parameters and process flow rules for these security checkpoints. Similarly, the security supervisor controlling the local hub 403 can set the operational parameters and process flow rules for security checkpoints and screening machines, which are under the control of local hub 403.

In an embodiment of the present specification, the centralized control system comprising the master hub 401 and the local hubs 402 and 403 is used to dynamically modify the security procedures to be followed for a specific person or object at any security checkpoint. In an embodiment, the centralized control system evaluates threat level associated with a passenger or a class of passengers and based on such threat level, the individual security checkpoints are instructed to follow corresponding security procedures.

In an embodiment, on a normal day, the security procedures to be followed are decided at the level of local hubs 402 and 402 for the security checkpoints under their control. However, in special circumstances, such as when the threat perception is high or when the passenger rush is very high, the security procedures are defined at the level of master hub 401 and the local hubs 402 and 403 are instructed to follow such procedures.

While FIG. 4A describes a two-tiered security architecture comprising a first level control layer represented by a two local hubs 402 and 403 and a second level control layer represented by the master hub 401, in alternate embodiments, the integrated security system of the present specification can be configured to have more than two level of control layers.

FIG. 4B illustrates a flow chart that describes the process flow of the integrated security inspection system deployed at an airport, in accordance with an embodiment of the present specification. At step 411, a passenger arrives in the check-in area of an airport. At step 412, the passenger provides his information (travel ticket, identification). In an embodiment, the passenger has the option to provide this information either through an automatic machine that issues the boarding pass or to an airline executive who feeds the information into a database on behalf of the passenger and issues the boarding pass as shown in step 413. At step 414, the passenger proceeds for security clearance. Once the system receives the passenger information as shown in step 412, at step 415, this information is sent to a central processor 420. This central processor may be, for example, central processor 202 in FIG. 2, local hubs such as A₀, B₀ in FIG. 1 or Master Hub M₀ also described in FIG. 1. In an embodiment, at step 416, the central processor 420 analyzes the threat level associated with the passenger. In an embodiment, the system uses various parameters such as, but not limited to, passenger demographic information, type of ticket, data, destination, and airline to analyze the threat level associated with a passenger. Some of the typical parameters that are used by the central processor in the process of evaluating the threat level associated with a passenger are presented in database 430. In an embodiment, the integrated security system of the present specification has been configured such that a passenger may be required to pass through different types of security checks based on the level of threat associated with a passenger. Accordingly, at step 417, the central processor selects a screening level that defines various types of security procedures to be followed by any passenger. At step 418, the central processor sends instructions containing information about various security procedures to be followed by the concerned passenger to individual scanning systems such as the metal detector, X-ray scanner, trace detector and other security systems present in the integrated security system. In an embodiment, the screening level selected for a passenger is based on his or her prior registration data available with the airport authorities or security agencies (e.g. TSA or Transport Security Administration). If the passenger is registered with the security agency, then a specific type of screening process is selected and if the passenger is not previously registered with the security agency, then a different type of screening process is selected.

In another exemplary embodiment, the screening level is based on the overall threat level and the overall threat level is color coded for ease of information display. For example, in an exemplary embodiment, the threat level is categorized using three different color codes such as Black, Amber and Green and the corresponding screening levels are classified into three different types such as “A”, “B” and “C”. If the estimated threat level is Black, then screening process “A” is selected and if the estimated threat level is Amber, then screening process “B” is selected and if the estimated threat level is Green, then screening process “C” is selected. It should be noted that each categorization represents a different threat level.

In another exemplary embodiment, the metal detection analysis is conducted based on the categorization of the individual passing through the security checkpoint. For example, in an exemplary embodiment, if the individual is a staff member working for that specific establishment, the metal detection analysis is not conducted and for all other people passing through the security checkpoint, metal threats are evaluated.

In the above embodiment, as the passenger provides his information in the check-in area, this information is accessed by the central processor to select an appropriate screening level and communicate the same to individual security checkpoints such as, but not limited to, a metal detector and/or baggage scanner. In an alternative embodiment, at secured establishments such as an airport the passenger information may already be present in a database and in such a case, the central processor can access the information and assign a screening level to each passenger even before the passenger arrives in check-in area of the airport.

One of ordinary skill in the art would appreciate that while the above process flow has been illustrated for an integrated security inspection system deployed at an airport, the process flow can be customized for other establishments such as, but not limited to, a multiplex, an office building, or railway station without departing from the spirit and scope of the present specification.

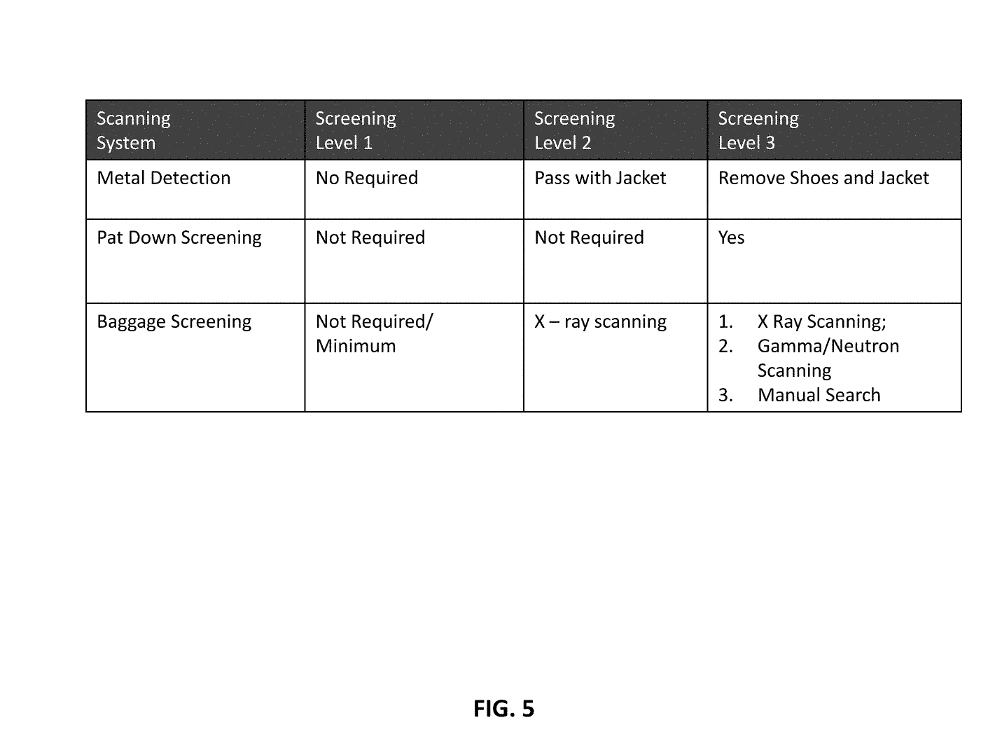

FIG. 5 illustrates an exemplary table that shows various screening levels and the associated security procedures in accordance with an embodiment of the present specification. The screening levels and the associated security procedures to be followed at each security checkpoint can be defined in many different ways depending on the security requirement. The table provided in FIG. 5 is only an exemplary illustration that shows that with an increasing threat perception, the security procedures to be followed at each security checkpoints become more stringent. As shown in the table in FIG. 5, in case the screening level is 1, there is no requirement of metal detector screening and pat down screening and only very minimum level of baggage screening may be conducted. In case the screening level associated with a person is 2, while there is no requirement for manual pat down screening, and the passenger may pass through the metal detector without removing his jacket, his baggage is required to be subjected to X-ray scanning. In case the screening level associated with a person is 3, the person is required to remove his shoes and jacket before passing through the metal detector. Further the person is required to undergo a manual pat down screening and his baggage is required to be subjected to X-ray scanning, Gamma ray scanning and manual search procedures.

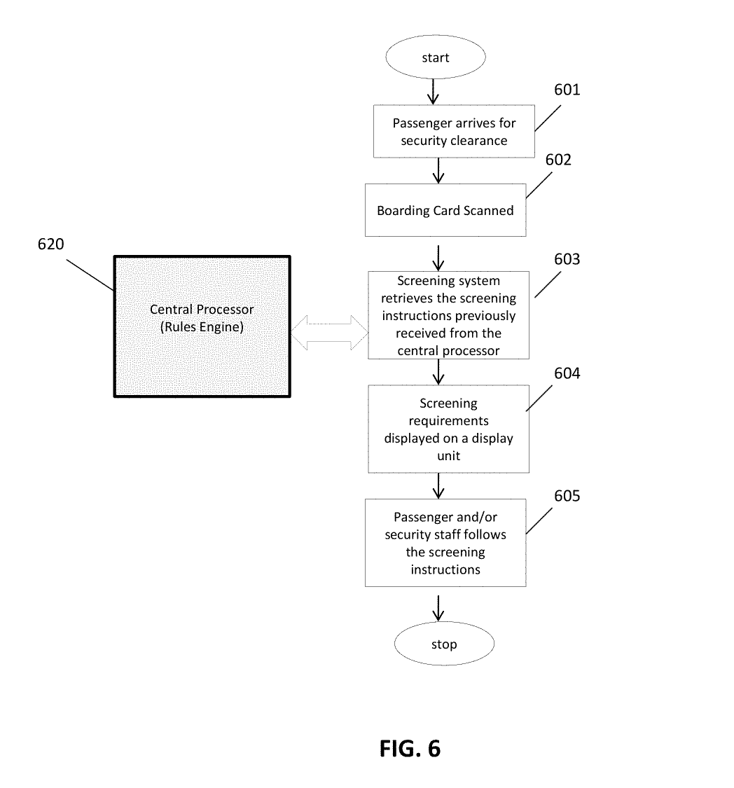

FIG. 6 illustrates the process flow at a specific exemplary security checkpoint managed in accordance with an embodiment of the present specification. In an embodiment of the present specification, the screening level and the associated security protocols to be followed for each specific passenger are dynamically communicated to a security checkpoint which can be accessed by the security personnel managing the respective checkpoint. In an embodiment as illustrated in FIG. 6, every passenger is required to provide his identification at each security checkpoint such that the security protocols to be followed for that passenger can be identified and followed. As shown in FIG. 6, at step 601, as the passenger arrives for security clearance at a security checkpoint such as at a metal detector or a baggage scanner, his boarding pass is scanned at step 602 to identify the passenger. In an embodiment, the boarding card information is taken with the help of an automatic boarding card scanner or through manual feeding. Subsequently, at step 603, in accordance with an embodiment of the present specification, once the screening system receives the passenger information, the screening system retrieves the specific security protocols to be followed for that passenger that are already received from the central processor 620. In the above embodiment, while the central processor 620 is shown in data communication with the screening machines, the security procedures to be followed for each passenger are communicated in advance (when the passenger is issued a boarding pass or even before) and the screening machines just retrieve the said procedures from a local database. At step 604, the identified security procedures or screening requirements are displayed on a display unit and at step 605, the passenger and/or the security staff follows the screening requirements mentioned on the display unit.

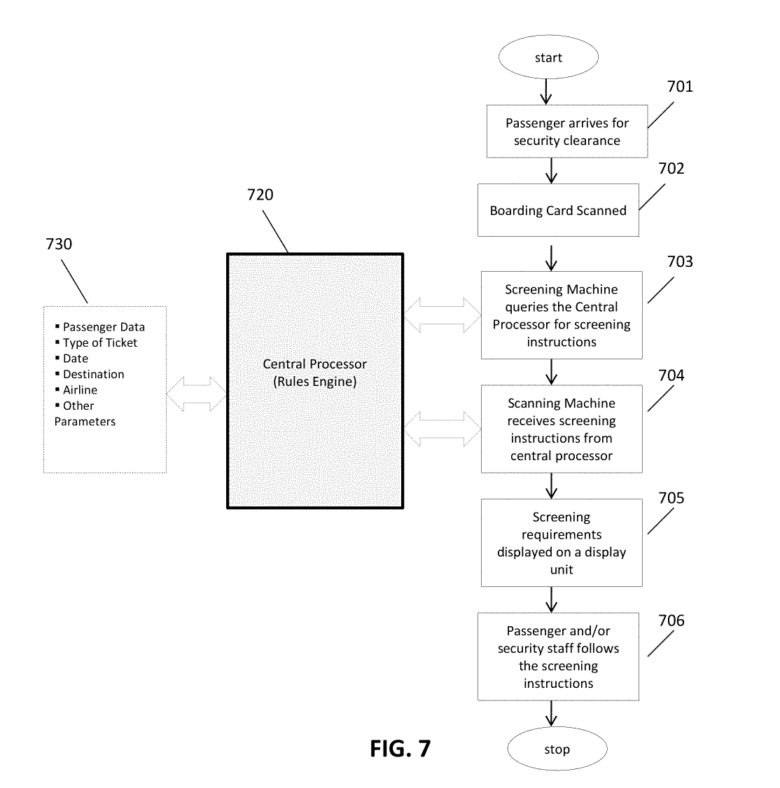

FIG. 7 illustrates the process flow at a specific security checkpoint managed in accordance with another embodiment of the present specification. In an embodiment of the present specification, the screening level and the associated security protocols to be followed for each specific passenger are generated in real time as the passenger arrives at the respective security checkpoint. As shown in FIG. 7, as the passenger arrives for security clearance at a specific security checkpoint at step 701, he is required to provide his information, which in an embodiment is accessed by scanning the boarding pass at step 702. Subsequently, at step 703, the screening system deployed at the respective security checkpoint queries the central processor 720 by providing the passenger information. At step 704, the central processor 720 communicates the security protocols to be followed for the specific passenger to the screening system. At step 705, the specific screening requirements received from the central processor 720 are displayed on a display unit and at step 706, the passenger and/or security personnel follows the screening instructions displayed on the display unit. In an embodiment, the central processor 720 maintains a database such as the database 730 that comprises various types of information such as, but not limited to passenger data, type of ticket, destination, and/or airline that are used to determine the threat level associated with each individual and assign a specific screening level for that individual.

In an embodiment, the integrated security system of the present specification is configured such that the various security procedures to be followed at any security checkpoints are determined at a central level and the equipment/machine deployed at each security checkpoint is accordingly instructed to follow the selected security procedures. In an embodiment of the present specification, the threat level associated with any individual who entering a secure area is analyzed and based on such threat level, the security procedures to be followed for security clearance of said individual are determined and communicated to the corresponding security checkpoints.

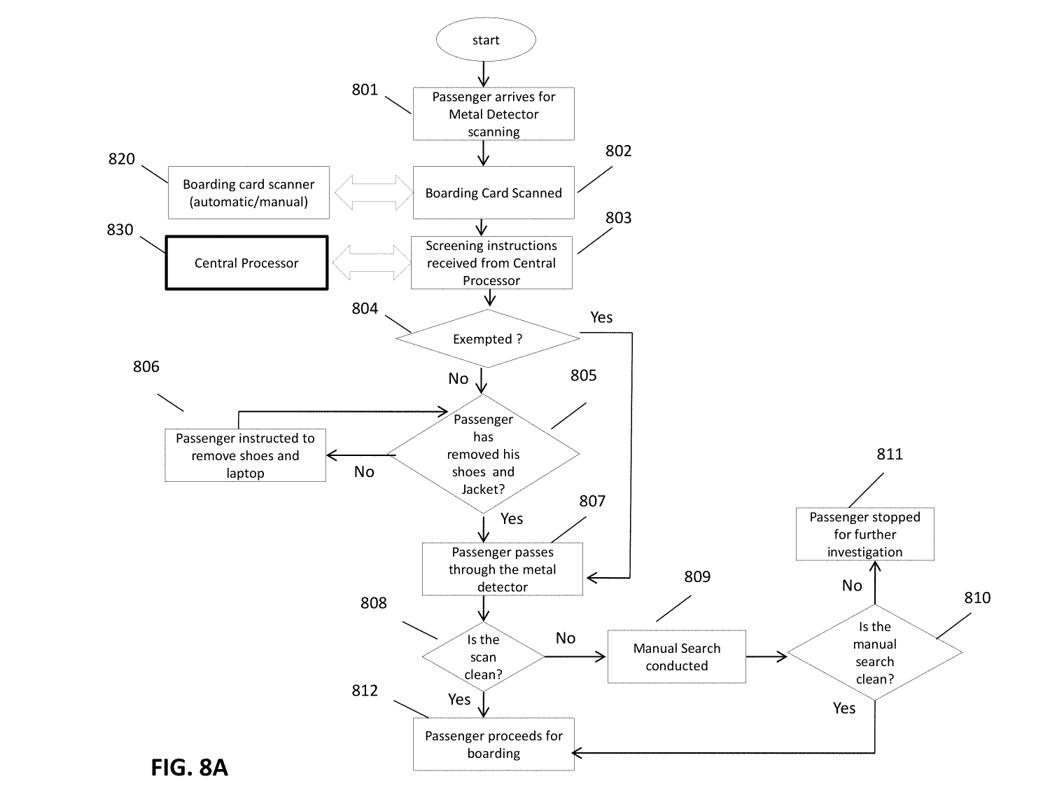

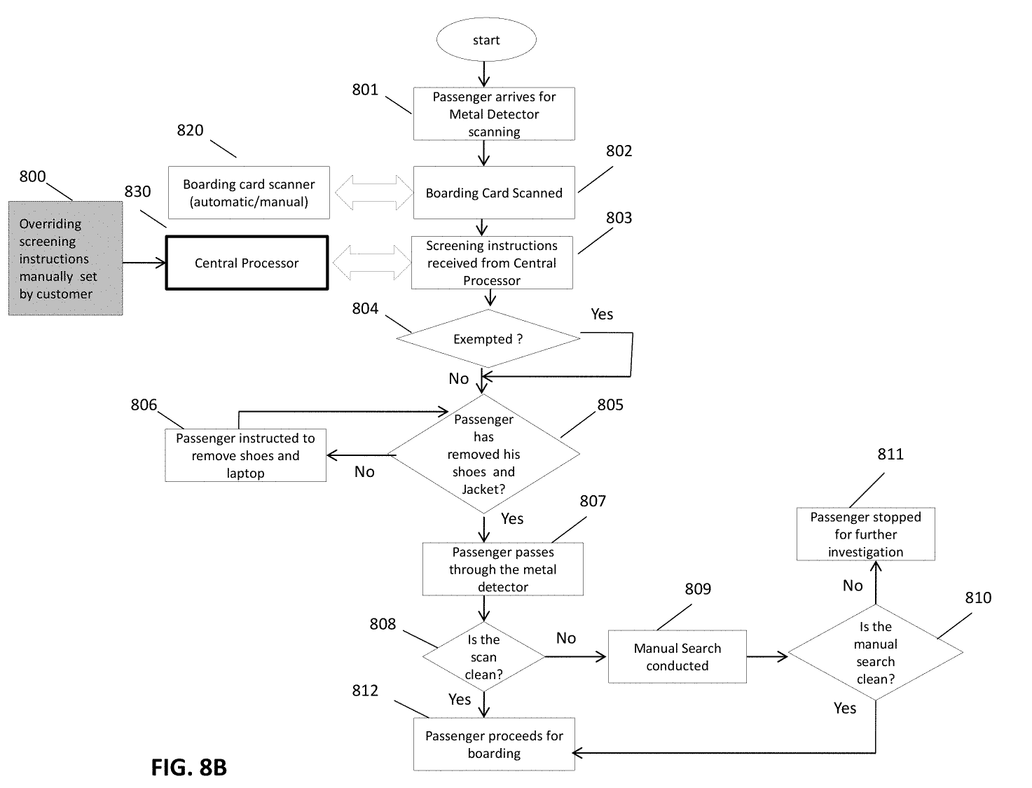

In an embodiment, the integrated security inspection system of the present specification deployed at an airport transit point facilitates selective application of security protocols to a certain category of passengers. FIG. 8A illustrates a flow chart that describes the process flow at a metal detector screening checkpoint wherein the passengers having a specific class of ticket are exempted from following certain security procedures. In the flow chart shown in FIG. 8A, the integrated security system of the present specification is used to exempt certain passengers from removing their jacket and shoes before passing through the metal detector. As shown in FIG. 8A, at step 801, the passenger arrives for metal detector screening. At step 802, the boarding pass of the passenger is scanned to identify the passenger. In an embodiment, the security checkpoint comprises an automatic boarding card scanner 820. In an alternate embodiment, a security staff manually feeds the boarding card information into the system. In an embodiment, the metal detector system is in dynamic communication with the central processor 830 and the boarding card scanner 820. In an embodiment, the information recorded from the boarding pass is shared with the central processor 830 such as the local hub 303 in FIG. 3, which evaluates the risk profile of the passenger and provides the corresponding screening instructions to the metal detector system. In an embodiment, the screening instructions comprise a screening level associated with the passenger.

In embodiments, the risk profile of a subject is programmatically determined by defining multiple factors/parameters, assigning a weight to each such factor, estimating the threat level associated with each such factor and aggregating the independent threat levels estimated for various defined factors to estimate the overall risk profile, which is stored into memory. In embodiments of the present specification, various types of factors are used to estimate the overall risk profile. In an exemplary embodiment, the system evaluates if the passenger has purchased the travel ticket from the same city to which the passenger belongs. If the ticket was not purchased from the same city, the estimated risk profile is classified at a higher level than in the case in which the ticket was purchased from the same city. In another exemplary embodiment, the mode of payment for purchasing the ticket is also monitored. For example, in an embodiment, if a cash method of payment is used, the risk profile is classified at a relatively higher level. In another exemplary embodiment, the system evaluates if the passengers travelling together in a group had purchased their tickets from a same location or from different locations. If the tickets were purchased from different locations, the system classifies the passengers travelling in that group under a higher level of risk profiling. In each case, the data (such as ticket purchase location, payment method, group purchasing locations, etc.) is stored in the database and accessed by the risk profile management system, as needed, to programmatically calculate the risk, as described above, and store the determined risk value in a memory.

In an embodiment, a screening level is associated with a set of security protocols that are required to be followed, such as illustrated in FIG. 5. At step 803, the system checks the screening level and corresponding procedures to be followed for the passenger. At step 804, the system checks whether the passenger is exempted from removing his shoes and jacket before passing through the metal detector. In case the passenger is exempted, the passenger passes through the metal detector at step 807 without removing his shoes and jacket. In case the passenger is not exempted, the system checks at step 805 if the passenger has removed his shoes and jacket and in case the passenger has not removed his belonging, the passenger is advised to remove this shoes and jacket as depicted at step 806. Once the passenger removes his shoes and jacket, the passenger is advised to pass through the metal detector at step 807. At step 808, the system checks the result of metal detector scan. In case, the metal detector scan is clean, the passenger proceeds for boarding at step 812. In case the metal detector scan is not clean, the passenger has to undergo manual search at step 809. At step 810, the outcome of manual search is evaluated. If the manual search is clean, the passenger is advised to proceed for boarding at step 812. In case the manual search is not clean, the passenger is stopped for further investigation at step 811.

The above described application of the present specification, wherein certain category of passengers having a very low risk profile can be exempted from following certain set of security procedures improves the overall system efficiency by enhancing the throughput of the corresponding security checkpoint.

The system disclosed in the present specification is highly versatile as the entire control resides at a central level instead of the individual machines and checkpoints. The individual machines and checkpoints just operate as per the instructions received from the central control system. The above mechanism allows the security supervisor to modify or change the operations and flow of a specific machine or the all security checkpoints depending on the business requirement. For example, in case the threat level is high on a specific day and the security supervisor deems it fit to not exempt any passenger to pass through the metal detector without removing his or her personal belongings such as jacket and shoes, he can just manually set the instructions at the control system and metal detector checkpoint receives these instructions from the central processor and modifies the process flow immediately. FIG. 8B illustrates a flow chart that describes the process flow at a metal detector checkpoint wherein none of the passengers is exempted from removing his jacket and shoes. The flow chart shown in FIG. 8B is similar to the flow chart described in FIG. 8A except at step 804, wherein it is evaluated whether a passenger is exempted from removing this shoes and jacket. Before commencement of screening, at step 800 instructions are received from the central processor instructing that none of the passengers be exempted from removing jacket and shoes. As shown in FIG. 8B, even in case the passenger is exempted as per local machine rules, at step 804, the passenger is nevertheless advised to remove his shoes and jacket at steps 805 and 806.

### Integrated Hotel Security Inspection System

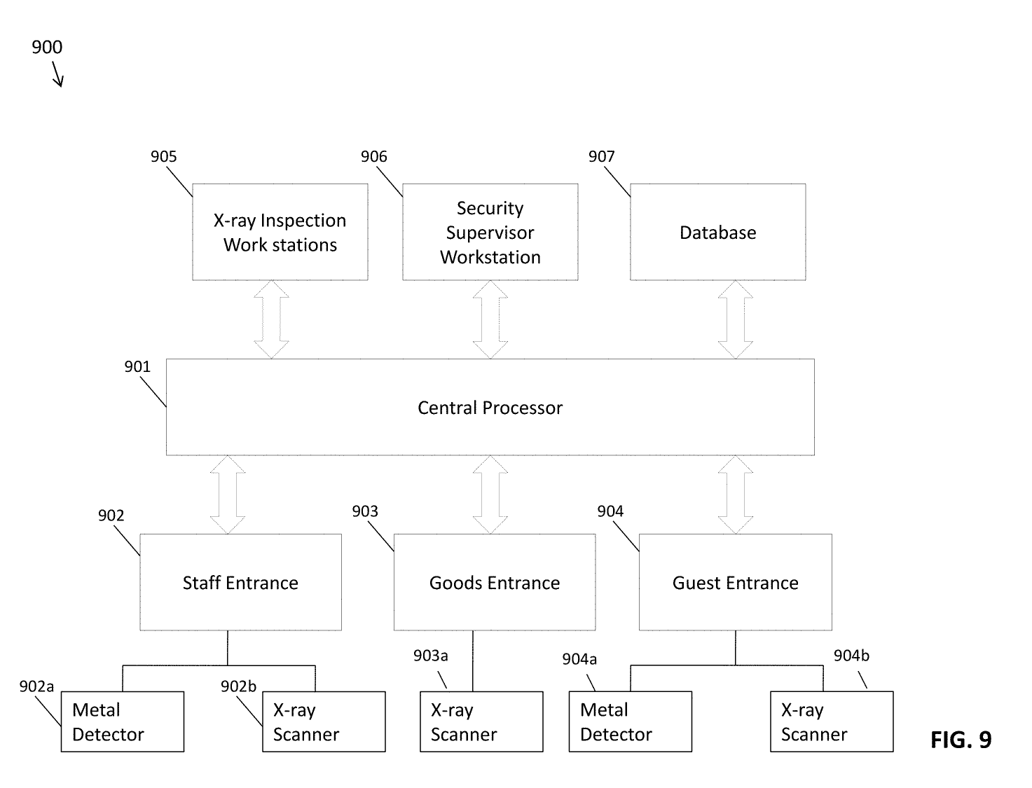

FIG. 9 illustrates the architecture of an integrated security inspection system deployed at a hotel in accordance with an embodiment of the present specification. As shown in FIG. 9, the integrated hotel security inspection system 900 comprises a central processor 901 that is coupled to multiple security checkpoints, such as the staff entrance checkpoint 902, goods entrance checkpoint 903 and the guest entrance checkpoint 904. In an embodiment, the staff entrance checkpoint 902 comprises a metal detector system 902a to screen staff members and an X-ray system 902b to screen the personal bags of staff members. In an embodiment, the goods entrance checkpoint 903 comprises an X-ray system 903a to screen the incoming goods and materials. In an embodiment, the guest entrance checkpoint 904 comprises a metal detector system 904a to screen guests and an X-ray system 904b to screen the luggage carried by guests. For ease of illustration, the architecture described in FIG. 9 is shown with only three checkpoints such that each checkpoint comprises a specific number of screening devices. In alternate embodiments of the present specification deployed at hotel premises, the number of checkpoints can be more than three and the number of screening devices coupled to each checkpoint can vary depending on the specific requirement of the respective site.

In an embodiment of the present specification, the data processing rules and business process flows are abstracted from the level of individual screening machines such as the metal detectors 902a, 904a and X-ray scanning systems 902b, 903a, 904b and that the operation of these machines as well as the process flow corresponding to various checkpoints is directly controlled from a centralized system comprising the central processor 901. In an embodiment, data such as the X-ray images, metal detector output (such as EMF (Electromagnetic Field) profiles of staff members and repeat guests) is not analyzed at the security checkpoints; rather this data is transmitted by the individual machines in real time to the central processor 901 for analytics and decision making. In an embodiment, the central processor 901 is coupled to a database 907 for storing the data received from various security checkpoints. In an embodiment, the data transmitted to the central processor 901 is analyzed by a centralized team operating from X-ray inspection workstations 905, which then issues further instructions to the respective security checkpoints. In an embodiment, a security supervisor 906 remotely controls the entire integrated security inspection system 900.

In embodiments, the EMF profile of an individual comprises information related to the signals recorded by various coil systems when that individual passes through a walk through metal detection system. The EMF information contains both amplitude and phase data of the signal induced in the receiver coil from its associated transmitter coil. EMF signatures are characteristic of body shape and density as well as other metallic features, such as an artificial joint that may have been surgically implanted within an individual.

As the various security checkpoints and the corresponding screening systems in integrated hotel security inspection system are controlled from a centralized system, the entire system is highly versatile and efficient. Depending on the threat level and other business conditions such as customer volume on a given day, the security supervisor 906 can issue instructions to increase or decrease the level of controls followed for screenings people and goods entering the hotel premise.

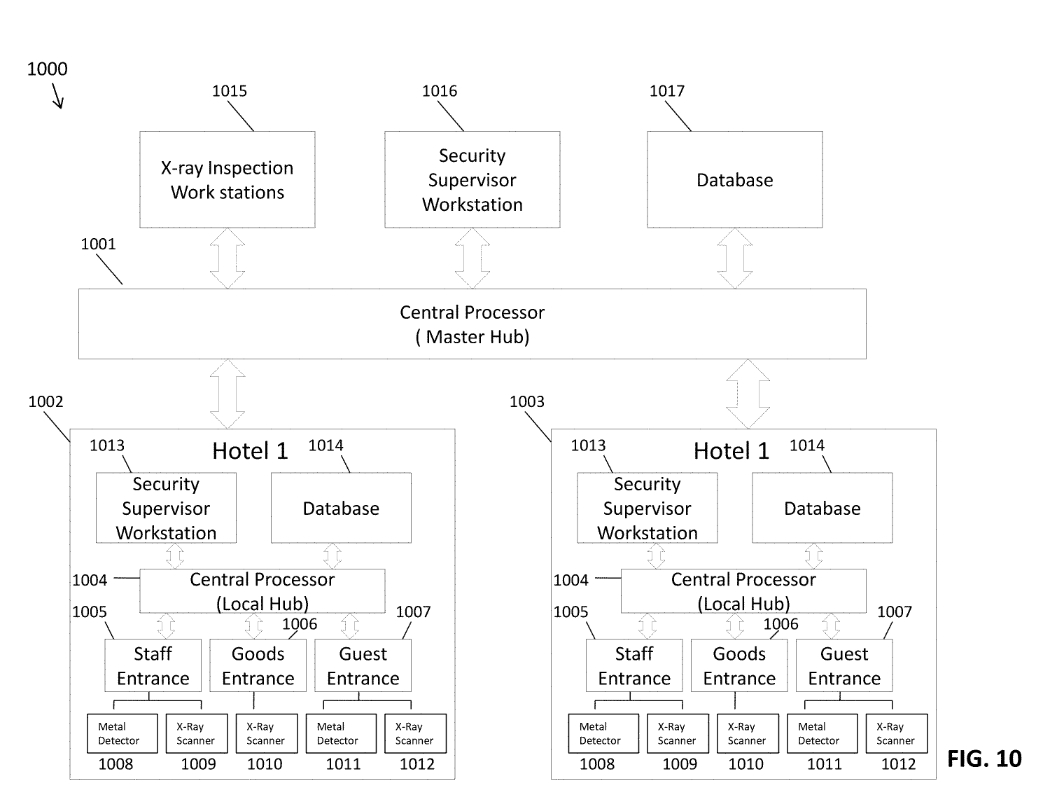

In embodiments of the present specification, the detection algorithms provide a certain probability of detection, Pd at a certain probability of false alarm Pfa. Normally, the algorithm is optimized to provide a certain Pd at an acceptable, low, Pfa. In high threat situations, Pd can be increased while allowing a corresponding increase in Pfa. This enhances the overall level of security but reduces checkpoint throughput. In an exemplary embodiment, to increase the Pd, people can be asked to divest differently in high threat situations (e.g. remove jacket, remove laptop) compared to low threat situations (keep jacket on and leave laptop in bag). The security supervisor 906 can issue instructions to increase or decrease the level of Pd and the level of Pfa accordingly varies. Accordingly, one method of the present invention is to instruct individuals to divest different objects based on the identified threat level. FIG. 10 illustrates the architecture of an integrated security inspection system that is deployed across multiple hotel sites in accordance with an embodiment of the present specification. As shown in FIG. 10, the integrated security inspection system 1000 comprises a centralized system comprising a master hub or central processor 1001 that is configured to remotely control the integrated security system operating across multiple hotel sites. In the embodiment shown in FIG. 10, the master hub 1001 is configured to remotely control the security systems across two hotel sites 1002 and 1003. The security system 1000 comprises a first level of centralized control provided locally at each hotel site through local hubs and a second level of centralized control provided at a remote location through the master hub 1001. The master hub 1001 is in real time data communication with the local hubs 1004 across various hotel sites such as the hotel sites 1002 and 1003 and remotely controls the security system at each hotel site by sending instructions to the corresponding local hubs. Security supervisors such as the security supervisors 1013 and security supervisor 1016 control the integrated security system at the level of local hubs and master hub respectively.

In an embodiment, each of the hotel sites 1002 and 1003 comprises a local hub or central processor 1004, which is coupled to multiple security checkpoints such as the staff entrance checkpoint 1005, good entrance checkpoint 1006 and the guest entrance checkpoint 1007. In an embodiment, the staff entrance checkpoint 1005 comprises a metal detector system 1008 to screen staff members and an X-ray system 1009 to screen the personal bags of staff members. In an embodiment, the goods entrance checkpoint 1006 comprises an X-ray system 1010 to screen the incoming goods and materials. In an embodiment, the guest entrance checkpoint 1007 comprises a metal detector system 1011 to screen guests and an X-ray system 1012 to screen the luggage carried by guests. In an embodiment of the present specification, the data processing rules and business process flows are abstracted from the level of individual screening machines such as the metal detectors 1008, 1011 and X-ray scanning systems 1009, 1010, 1012 and the operation of these machines as well as the process flow corresponding to various security checkpoints is directly controlled from a centralized system comprising the local hub 1004 and/or the master hub 1001. In an embodiment, data such as the X-ray images, metal detector output (such as EMF (Electromagnetic Field) profiles of staff members and repeat guests) is not analyzed at the security checkpoints; rather this data is transmitted by the individual machines in real time to the local hub 1004 for analytics and decision making. In an alternate embodiment, the local hub 1004 further transmits this data in real time to the master hub 1001 for analytics and decision making.

In embodiments of the present specification, the analytics and decision making is mainly performed at the level of local hub 1004 so that a high level of security is maintained even if the communication link between the local hub 1004 and the master hub 1001 is not functioning for some reason. In an embodiment, the master hub sends the specific parameters and rules, which are used to evaluate the threat levels and maintains a copy of threat databases at the local hub in order to maximize the system performance and minimize network latencies.

In an embodiment, each of the local hubs 1004 is coupled to a database 1014 and the master hub 1001 is coupled to a database 1017 for data storage.

In an embodiment, the images captured by X-ray screening machines across multiple hotel sites are not processed locally at the level of local hubs 1004 but are transmitted to the level of master hub 1001 for evaluation. A centralized team of security personnel operating from X-ray inspection workstations 1015 receives these X-ray images for analysis and decision making.

For the ease of illustration, the above embodiment comprises security system that covers only two hotel sites; in alternate embodiments, the total number of hotel sites that can be covered the integrated security inspection system of present specification can be much higher. In an embodiment, a security system covering a large chain of hotels comprising over 500 hotel sites across multiple countries is controlled through a central control system or master hub 1001. In such an integrated security system, instead of having just two layers of control comprising a local hub and a master hub, in an embodiment, the system provides various intermediate control layers at a city, state or country level which are managed by respective security supervisors. Such an integrated hotel security inspection system is highly versatile and provides various options to the security officers to manage the security arrangement.

In an embodiment, the security supervisor controlling the master hub 1001 can control the local hubs by setting an alert parameter which is then used to individually set the scanning parameters of each machine in each local hub. In an embodiment, the alert parameter represents the threat level. In an embodiment, the threat level is depicted by color code wherein red color is used to represent a high level of threat and a yellow color is used to represent a normal or low level of threat.

In embodiments, the alert parameter that communicates the overall threat level and the security protocol to be followed by various screening machines is defined or set based on multiple factors. In some embodiments the alert parameter is based on external factors such as the overall threat perception or advisory received from government security agencies. In some embodiments, the alert parameter is automatically set to a higher level on certain predefined dates of a year (e.g. Independence Day, Christmas) and in it is set to a relatively lower level on other days. In some other embodiments, the alert parameter is based on internal factors such as the information received from various screening machines (e.g. metal detector, X-ray screening machine) deployed in one or more checkpoints. In exemplary embodiments, the data communicated by screenings machines also provides information related to the severity of the threat type. For example, a watch detected in a metal detector may be safely ignored whereas a weapon would result in a significant alert. In embodiments, the alerts are raised centrally by collating information received from various screening machines. For example, if weapons are detected at multiple checkpoints within a short period of time, a Critical or a Very High level alert may be raised whereas if only a single weapon is detected, the alert level may be set to High. On the other hand, if the information provided by individual screening machines show that the throughput of the system is low while the traffic is high and no significant threat has been detected on that day, the alert parameters may be set to a Low level thereby reducing the screening requirements at one or more individual screening machines.

The throughput level of a screening machine is normally measured in passengers screened per hour. This is determined by several factors which include the probability of false alarms and the extent of divest required prior to screening. Throughput can be managed by selecting the allowed probability of false alarm (Pfa) and divest requirements. The more divest required (e.g. shoes, coats, laptops), the lower the throughput but the higher the level of security. In an alternate embodiment of the present specification, the alert parameter or the screening requirements are modified by changing the required throughput rate. The security supervisor controlling the master hub 1001 can set the required throughput rate, which is then used to individually set the scanning parameters of each machine in each local hub. In case the security supervisor increases the throughput rate, the divest requirements are relaxed and accordingly the probability of false alarms is reduced. On the contrary in case the security supervisor reduces the throughput rate, the divest requirements are increased and the probability of false alarms increases.

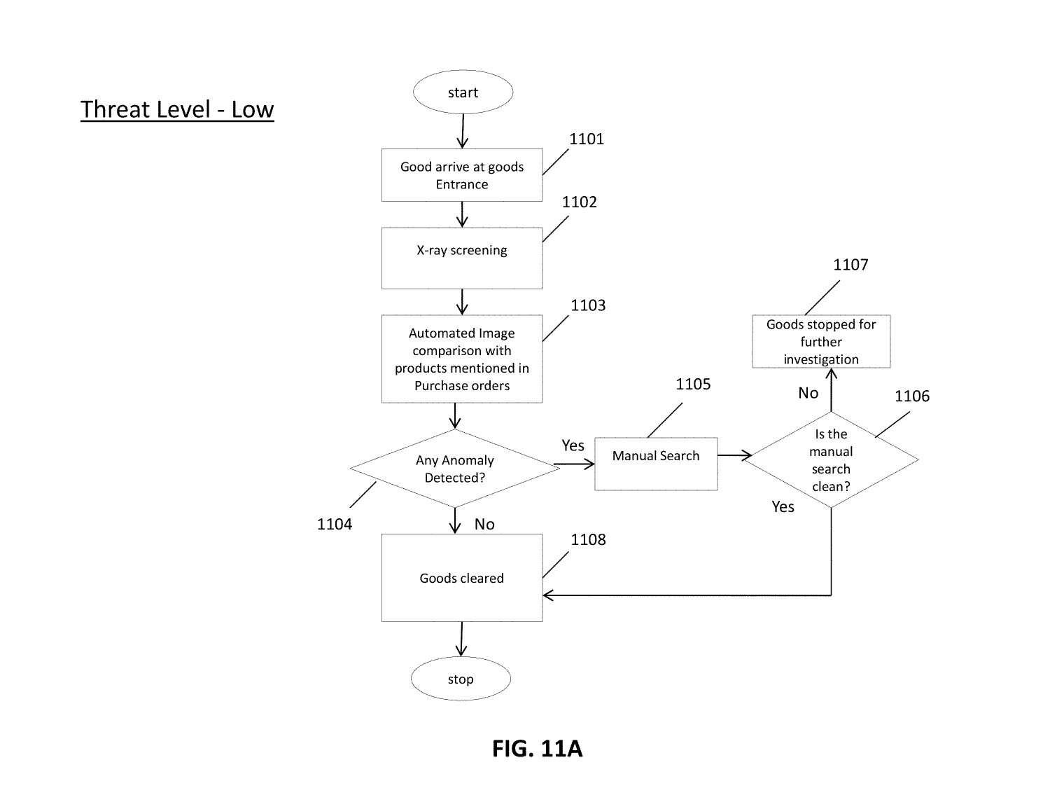

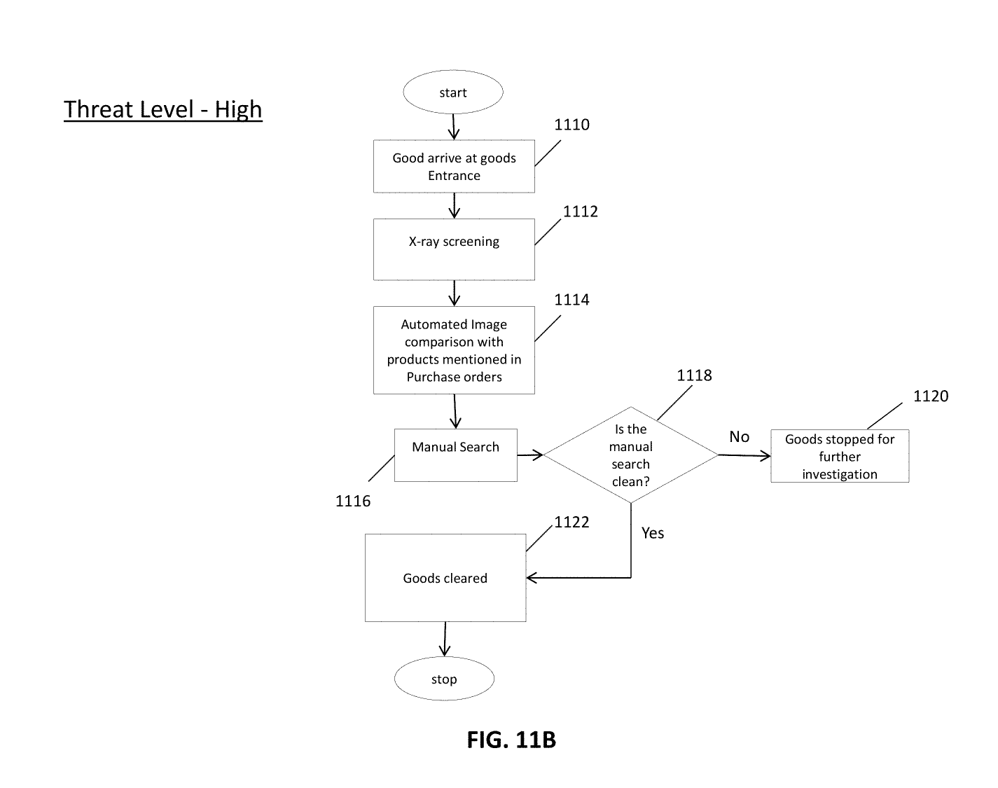

In an embodiment, the system is configured to operate on two levels of threat perception—low and high. In case the threat perception is low, the security procedures followed at various checkpoints are less strict and in case the threat perception is high, the security procedures followed at various checkpoints are more stringent. In an embodiment, the security supervisor can simply change the alert parameter for a specific subset of hotel sites from a centralized processor such as the master hub 1001 and the master hub 1001 sends corresponding instructions to the local hubs at selected sub set of hotel sites for which the alert parameter has to be changed. The local hubs at these hotel sites in turn send instructions to the corresponding security checkpoints under their control. In an embodiment of this specification, the security supervisor can change the alert parameter for specific checkpoints such as a guest entrance checkpoint for a specific set of hotels. Flowcharts described in FIG. 11A to FIG. 13B describe how the operational and the process flow associated with various security checkpoints such as goods entrance checkpoint, staff entrance checkpoint and guest entrance checkpoints are modified based on threat parameters.

FIG. 11A illustrates a flow chart describing an exemplary process flow at a goods entrance checkpoint when the threat level is classified as low. As shown in flow chart 11A, at step 1101, the good arrive at goods entrance and at step 1102, the goods are subjected to X-ray screening. At step 1103, the images of objects detected in X-ray screening are compared with the standard images of objects that are mentioned in corresponding purchase orders. At step 1104, the system evaluates if there is any type of anomaly. In an embodiment, the comparison and evaluation of the images takes place at a local processor/hub level. In case no anomaly is detected, the goods are cleared as shown in step 1108. In case any kind of anomaly is detected, the goods are subjected to manual search at step 1105. At step 1106, the results of manual search are evaluated. In case the manual search is clean, the goods are cleared as shown in step 1108. In case the manual search is not clean, the goods are stopped for further investigation as shown in step 1107.

In case the security supervisor operating the centralized control system perceives a higher threat perception, he can accordingly set the alert parameter as high through the master hub and the corresponding instructions are sent to various security checkpoints and the process flow followed at such checkpoint is accordingly modified. FIG. 11B illustrates a flow chart that describes a modified exemplary process flow at a goods entrance checkpoint when the threat level is classified as high. As shown in flow chart 11B, at step 1110, the good arrive at goods entrance and at step 1112, the goods are subjected to X-ray screening. At step 1114, the images of objects detected in X-ray screening are compared with the standard images of objects that are mentioned in corresponding purchase orders. Instead of performing a manual search only on goods in which some kind of anomaly is detected (as depicted in the flowchart shown in FIG. 11A in case of low threat perception), the system performs a manual search on all types of goods at step 1116 as the threat parameter is set as high. At step 1118, the results of manual search are evaluated. In case the manual search is clean, the goods are cleared as shown in step 1122. In case the manual search is not clean, the goods are stopped for further investigation as shown in step 1120.

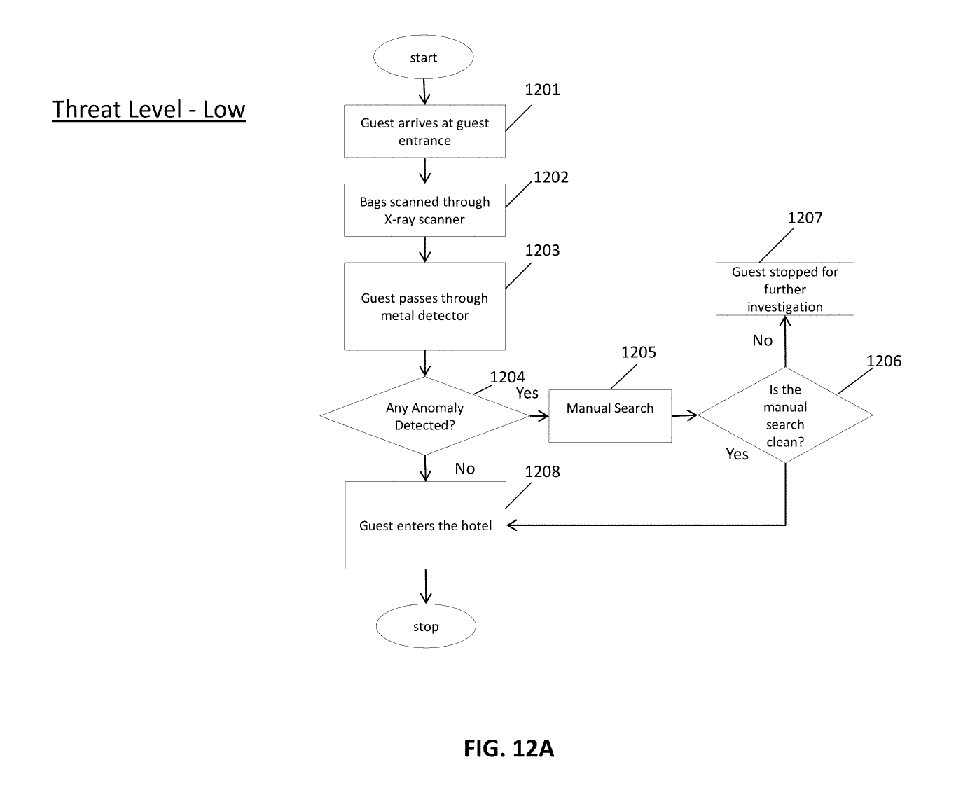

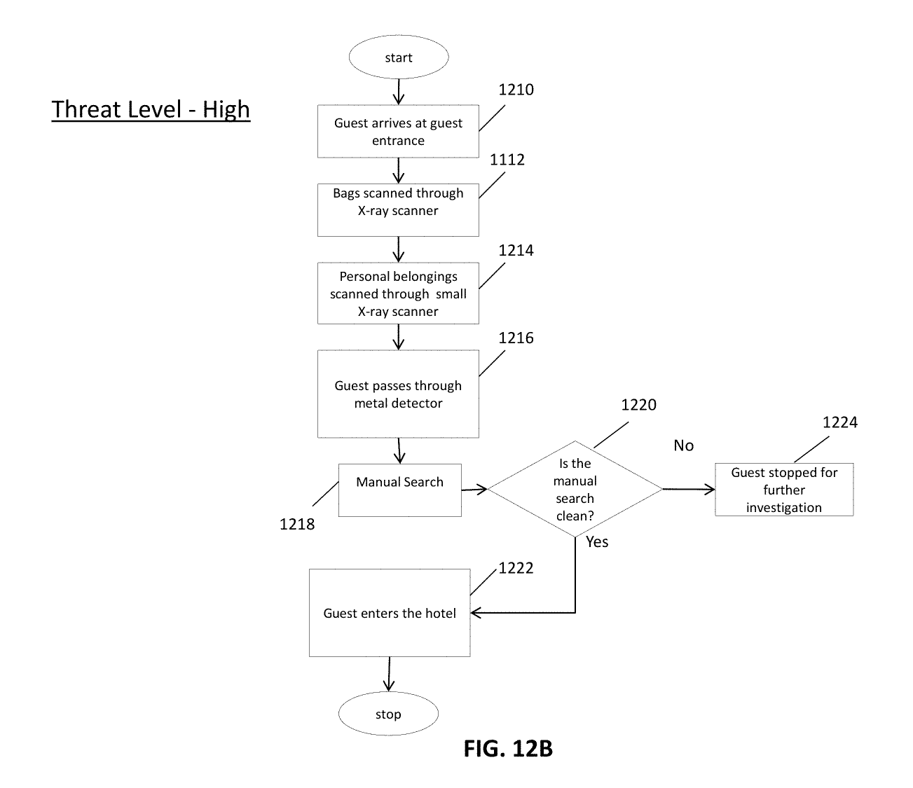

FIG. 12A illustrates a flow chart describing an exemplary process flow at a guest entrance checkpoint when the threat level is classified as low. As shown in flow chart 12A, at step 1201, a guest arrives at the guest entrance and at step 1202, the baggage carried by the guest is subjected to X-ray screening. At step 1203, the guest passes through a metal detector. At step 1204, the system evaluates if there is any type of anomaly detected during X-ray screening and metal detector scanning. In an embodiment, the detection of anomaly takes place at a local processor/hub level. In case no anomaly is detected, the guest enters into the hotel as shown in step 1208. In case there any kind of anomaly is detected, the guest is subjected to a manual search at step 1205. At step 1206, the results of manual search are evaluated. In case the manual search is clean, the guest can enter the hotel as shown in step 1208. In case the manual search is not clean, the guest is stopped for further investigation as shown in step 1207.

FIG. 12B illustrates a flow chart describing an exemplary process flow at a guest entrance checkpoint when the threat level is classified as high. As shown in flow chart 12B, at step 1210, a guest arrives at the guest entrance checkpoint and at step 1212, the luggage carried by the guest is subjected to X-ray screening. At step 1214, the personal belongings carried by the guest such as wallet, mobile phone are separately subjected to an X-ray screening. Typically, a separate X-ray system is deployed to screen such personal belongings. At step 1216, the guest passes through a metal detector. Instead of performing a manual search on guests only in case when some kind of anomaly is found during metal detector screening or X-ray screening (as depicted in the flowchart shown in FIG. 12A in case of low threat perception), the system performs a manual search on all guests at step 1218 as the threat parameter is set as high. At step 1220, the results of manual search are evaluated. In case the manual search is clean, the guest can enter the hotel as shown in step 1222. In case the manual search is not clean, the guest is stopped for further investigation as shown in step 1224.

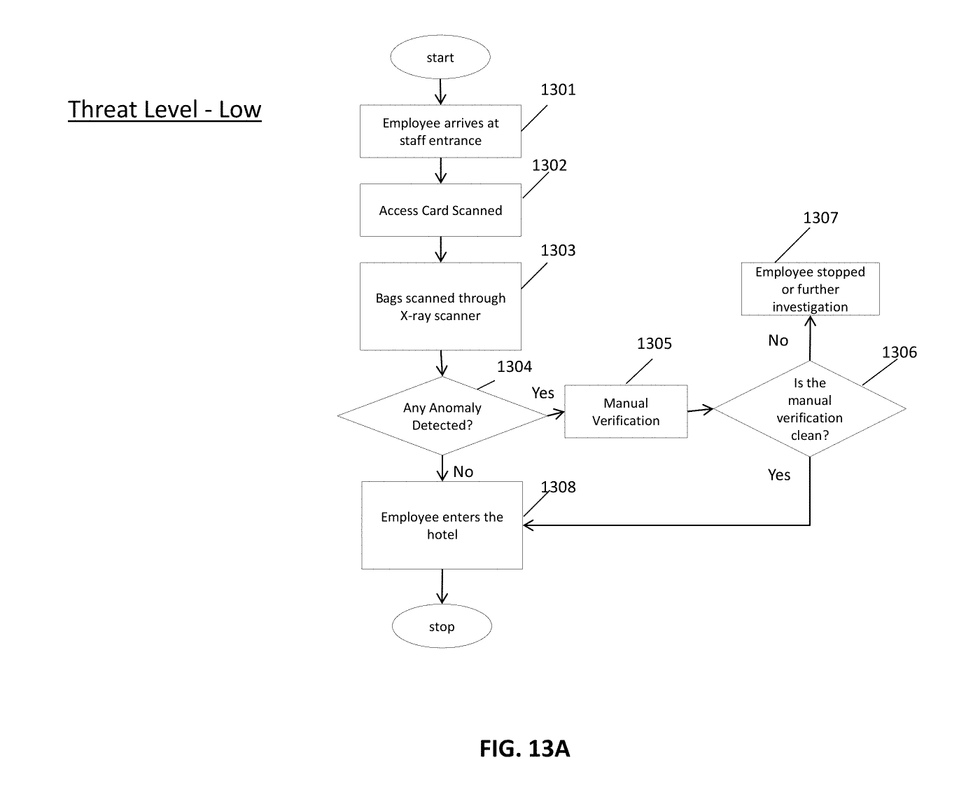

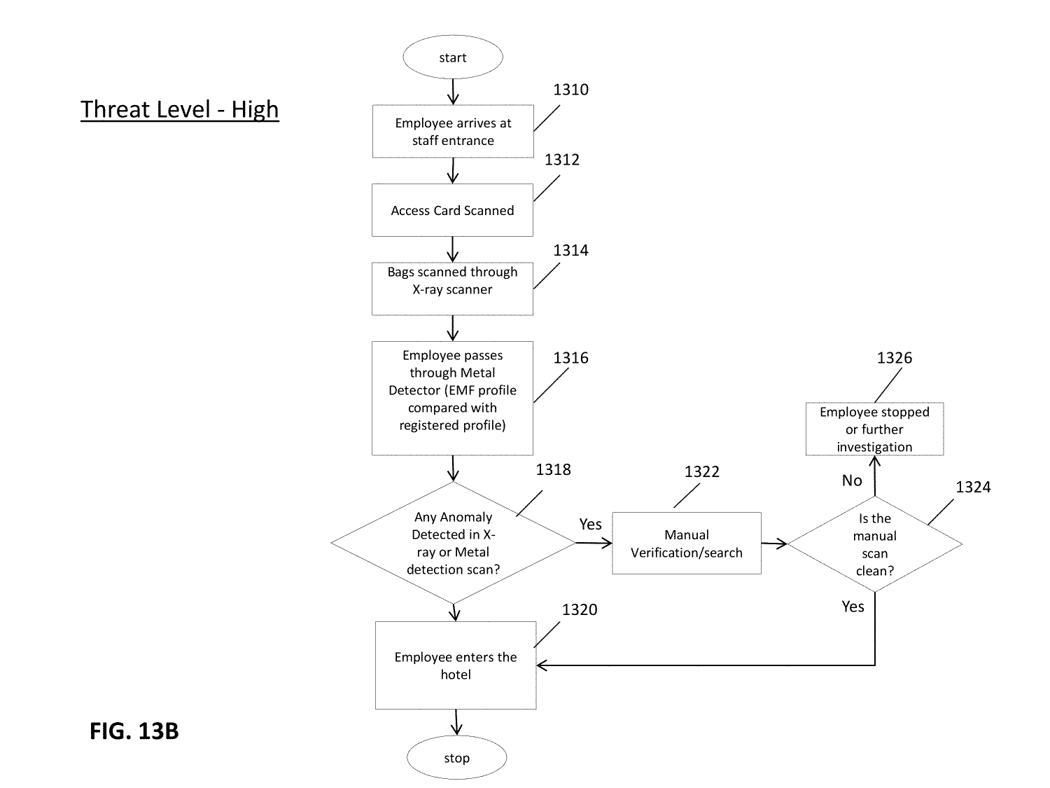

FIG. 13A illustrates a flow chart describing the exemplary process flow at a staff entrance checkpoint when the threat level is classified as low. As shown in flow chart 13A, at step 1301, an employee arrives at the staff entrance checkpoint and at step 1302, the access card of the employee is scanned. At step 1303, the bags carried by the employee are screened with an X-ray scanner. At step 1304, the system evaluates if there is any type of anomaly detected during X-ray screening or if the access card is not recognized. In case no anomaly is detected, the employee enters the hotel as shown in step 1308. In case any kind of anomaly is detected, the employee is subjected to a manual verification and search process at step 1305. At step 1306, the results of manual verification and search process are evaluated. In case the manual verification is clean, the employee can enter the hotel as shown in step 1308. In case the manual verification is not clean, the employee is stopped for further investigation as shown in step 1307.

FIG. 13B illustrates a flow chart describing an exemplary process flow at a staff entrance checkpoint when the threat level is classified as high. As shown in flow chart 13B, at step 1310, an employee arrives at the staff entrance checkpoint and at step 1312, the access card of the employee is scanned. At step 1314, the bags carried by the employee are screened with an X-ray scanner. At step 1316, the employee is required to pass through a metal detector wherein the EMF (electromagnetic field) profile of the employee is compared with his or her standard EMF profile that is stored in the centralized server.

In an embodiment, the standard EMF profile of an employee is gathered during a one-time registration/profiling process. By way of example, a standard EMF profile can be collected at the time of joining when the employees are issued their ID badge. This is a one-time measurement. In embodiments, the day-to-day measurements taken when the employee passes through the security checkpoint (employee EMF profile) are statistically compared with the stored Standard EMF profile to look for anomalies.

In another embodiment, the standard EMF profile is calculated and regularly updated by averaging the various parameters captured in the EMF profile of an individual over a specific period (e.g. last thirty days).

At step 1318, the system evaluates if there is any type of anomaly detected during X-ray screening or metal detector scan or if the access card is not recognized. In case no anomaly is detected and the access card is working, the employee enters the hotel as shown in step 1320. In case any kind of anomaly is detected in previous steps, the employee is subjected to a manual verification and search process at step 1322. At step 1324, the results of manual verification and search process are evaluated. In case the manual verification is clean, the employee can enter the hotel as shown in step 1320 In case the manual verification is not clean, the employee is stopped for further investigation as shown in step 1326.

The above mentioned flowcharts illustrate only a few specific examples wherein the process flow associated with a security checkpoint or the scanning parameters associated with scanning machines are modified based on instructions received from a central processor. In embodiments of the present specification various other such process flow modifications can be affected depending on the business requirement and threat perception without departing from the core spirit and scope of the present specification.

The above mentioned embodiments describe application of the integrated security system of the present specification in two specific types of establishments—airports and hotels. In alternate embodiments of the present specification, the integrated security system of the present specification can be deployed in other locations such as, but not limited to, border control, sea ports, commercial buildings, and/or offices/office buildings without departing from the spirit and scope of the present specification.

The above examples are merely illustrative of the many applications of the system of present invention. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

In the description and claims of the application, each of the words “comprise” “include” and “have”, and forms thereof, are not necessarily limited to members in a list with which the words may be associated.

We claim:

1. An integrated security inspection system comprising:
a plurality of security checkpoints wherein at least one of said security checkpoints comprises at least one screening device; and,
a central processor, remotely located from at least a portion of said plurality of security checkpoints and in data communication with said plurality of security checkpoints, wherein the central processor comprises at least one processor and memory and wherein said at least one processor is programmed to execute a plurality of programmatic instructions that, when executed, define at least one process flow and wherein said at least one process flow defines operational parameters for the at least one screening device.

2. The integrated security system of claim 1, wherein said at least one screening device may comprise at least one of: a metal detector, an ultrawide band imaging system, a millimeter wave imaging system, a terahertz imaging system, an X-ray screening system, a gamma ray detector, a neutron detector, a biometric scanner, an access card scanner, an ID card scanner, and/or a boarding pass scanner.

3. The integrated security inspection system of claim 1, wherein the central processor is configured to modify said operational parameters by selecting a different process flow and issuing instructions from the central processor to the at least one screening device.

4. The integrated security inspection system of claim 1, wherein the operational parameters of the at least one screening device are adapted to be modified by instructions issued from the central processor.

5. The integrated security inspection system of claim 1, wherein said at least one processor is further programmed to execute a plurality of programmatic instructions that, when executed, repurposes the at least one screening device from screening passengers at an airport to scanning guests at a hotel.

6. The integrated security inspection system of claim 1, wherein said at least one processor is further programmed to execute a plurality of programmatic instructions that, when executed, define a security procedure to be performed by the at least one screening device and wherein said at least one screening device is configured to receive and execute said security procedure.

7. The integrated security inspection system of claim 1, wherein said at least one processor is further programmed to execute a plurality of programmatic instructions that, when executed, create a risk profile of an individual passing through said integrated security inspection system and, based on said risk profile, select a specific screening level for said individual from a set of predefined screening levels.

8. The integrated security inspection system of claim 7, wherein each of said screening levels represents a specific set of security procedures to be followed for said individual.

9. The integrated security inspection system of claim 7, wherein based on said selected screening level, said at least one processor is further programmed to execute a plurality of programmatic instructions that, when executed, send instructions regarding the security procedure to be followed for said individual to the respective security checkpoints and/or screening devices.

10. The integrated security inspection system of claim 1, wherein said at least one processor is further programmed to execute a plurality of programmatic instructions set by a security supervisor that, when executed, defines the security procedures to be followed for a specific set of people.

11. The integrated security system of claim 1, wherein said central processor is coupled to a database to store the data captured by screening machines deployed at said security checkpoints.

12. The integrated security system of claim 1, wherein said at least one processor is further programmed to execute a plurality of programmatic instructions that, when executed, defines a security procedure corresponding to the identification details of an individual arriving at a specific security checkpoint shared in real time with said central processor.

13. The integrated security system of claim 1, wherein said at least one processor is further programmed to execute a plurality of programmatic instructions that, when executed, receive data indicative of individuals passing through the integrated security system and generate a risk profile for each of said individuals.

14. The integrated security system of claim 1, wherein one of said plurality of security checkpoints is located at a hotel and wherein said at least one processor is further programmed to execute a plurality of programmatic instructions that, when executed, receives data indicative of staff member and guest screenings, processes said data to determine a threat level and, based upon said determination, instructs individuals to divest objects.

15. The integrated security system of claim 1, wherein one of said plurality of security checkpoints is located at an airport and wherein said at least one processor is further programmed to execute a plurality of programmatic instructions that, when executed, receives data indicative of passenger screenings, processes said data to determine a threat level and, based upon said determination, directs passengers to a manual pat down search or allows passengers to proceed to board an aircraft.

16. An integrated security inspection system comprising:
a first security checkpoint wherein said first security checkpoint comprises a first screening device;
a second security checkpoint wherein said second security checkpoint comprises a second screening device, wherein said first security checkpoint is remote from said second security checkpoint;
a third security checkpoint wherein said third security checkpoint comprises a third screening device, wherein said third security checkpoint is remote from both said first and second security checkpoint;
a first local hub wherein the first local hub is configured to control a process flow associated with each of said first security checkpoint and its first screening device and said second security checkpoint and its second screening device; and,
a second local hub wherein the second local hub is configured to control a process flow associated with said third security checkpoint and its third screening device, wherein said second local hub is located remote from the first local hub; and
a master hub which is configured to control each of said first local hub and second local hub.

17. The integrated security system of claim 16, wherein each of said first, second, and third screening device may comprise at least one of: a metal detector, an ultrawide band imaging system, a millimeter wave imaging system, a terahertz imaging system, an X-ray screening system, a gamma ray detector, a neutron detector, a biometric scanner, an access card scanner, an ID card scanner, and a boarding pass scanner.

18. The integrated security inspection system of claim 16, wherein said security system is deployed across multiple hotel sites and wherein each of said local hubs controls a plurality of security checkpoints deployed at a specific hotel site, wherein one of said plurality of security checkpoints is located at a staff entrance and wherein said at least one processor is further programmed to execute a plurality of programmatic instructions that, when executed, receives data indicative of a staff member access card, processes said data to determine a threat level and, based upon said determination, allows an employee to enter the hotel site or subjects the employee to manual verification and search.

19. The integrated security inspection system of claim 16, wherein said security system is deployed across multiple hotel sites and wherein each of said local hubs controls a plurality of security checkpoints deployed at a specific hotel site, wherein one of said plurality of security checkpoints is located at a guest entrance and wherein said at least one processor is further programmed to execute a plurality of programmatic instructions that, when executed, receives data indicative of a guest metal detector screening, processes said data to determine a threat level and, based upon said determination, allows said guest to enter the hotel site or subjects the guest to a manual search.

20. The integrated security inspection system of claim 16, wherein said security system is deployed across multiple hotel sites and wherein each of said local hubs controls a plurality of security checkpoints deployed at a specific hotel site, wherein one of said plurality of security checkpoints is located at a goods entrance and wherein said at least one processor is further programmed to execute a plurality of programmatic instructions that, when executed, receives data indicative of a goods X-ray screening, processes said data to determine a threat level and, based upon said determination, clears the goods to enter the hotel site or subjects the goods to a manual search.

21. The integrated security inspection system of claim 16, wherein said master hub and said local hubs are configured to issue instructions to modify the process flow corresponding to any specific security checkpoint.

22. The integrated security inspection system of claim 16, wherein said master hub and said local hubs are configured to issue instructions to modify the functional and operational parameters corresponding to any screening device deployed in the said security system.

23. The integrated security inspection system of claim 16, wherein the security procedures to be followed at any security checkpoint are defined at the level of the corresponding local hub or the master hub and said master hub and said local hubs are configured to issue instructions to direct the screening machines and/or personnel deployed at such security checkpoints to follow the defined procedures.

24. The integrated security inspection system of claim 16 configured to create a risk profile of an individual passing through said integrated security inspection system and, based on said risk profile, select a specific screening level for said individual from a set of predefined screening levels.

25. The integrated security inspection system of claim 24, wherein each of said screening levels represents a specific set of security procedures to be followed for said individual.

26. The integrate security inspection system of claim 24, wherein based on said selected screening level, the local hub and/or master hub are configured to send instructions regarding the security procedures to be followed for said individual to the respective security checkpoints and/or screening devices.

27. The integrated security inspection system of claim 16, wherein said master hub and/or said local hubs are configured to follow security procedures for a specific group of people set by a security supervisor.

28. A method of screening an individual or object comprising the steps of:
providing an integrated security inspection system comprising: a plurality of security checkpoints wherein at least one of said security checkpoints comprises at least one screening device; and a central processor, remotely located from at least a portion of said plurality of security checkpoints and in data communication with said plurality of security checkpoints, wherein the central processor comprises at least one processor and memory and wherein said at least one processor is programmed to execute a plurality of programmatic instructions that, when executed, define at least one process flow and wherein said at least one process flow defines operational parameters for the at least one screening device;
screening said individual or object using a first screening device to generate a threat level associated with said individual or object; and
advancing said individual or object to additional screening devices and/or security checkpoints for further screening or allowing said individual or object to pass said integrated security inspection system based on said generated threat level.

29. A method of screening individuals or objects comprising the steps of:
providing an integrated security inspection system comprising: a first security checkpoint wherein said first security checkpoint comprises a first screening device; a second security checkpoint wherein said second security checkpoint comprises a second screening device, wherein said first security checkpoint is remote from said second security checkpoint; a third security checkpoint wherein said third security checkpoint comprises a third screening device, wherein said third security checkpoint is remote from both said first and second security checkpoint; a first local hub wherein the first local hub is configured to control a process flow associated with each of said first security checkpoint and its first screening device and said second security checkpoint and its second screening device; and, a second local hub wherein the second local hub is configured to control a process flow associated with said third security checkpoint and its third screening device, wherein said second local hub is located remote from the first local hub; and a master hub which is configured to control each of said first local hub and second local hub;
screening said individual or object using said first screening device to generate a threat level associated with said individual or object; and
advancing said individual or object to additional screening devices and/or security checkpoints for further screening or allowing said individual or object to pass said integrated security inspection system based on said generated threat level.
